(19) United States
(12) Patent Application Publication
(10) Pub. No.: US 2017/0300939 A1
(43) Pub. Date: Oct. 19, 2017

(54) OPTIMIZING PROMOTIONAL OFFER MIXES USING PREDICTIVE MODELING

(71) Applicants: Anto CHITTILAPPILLY, Waltham, MA (US); Payman SADEGH, Alpharetta, GA (US)

(72) Inventors: Anto CHITTILAPPILLY, Waltham, MA (US); Payman SADEGH, Alpharetta, GA (US)

(21) Appl. No.: 15/132,683

(22) Filed: Apr. 19, 2016

(51) Int. Cl. G06Q 30/02; G06N 99/00

(52) U.S. Cl. CPC G06Q 30/0202; G06N 99/005; G06Q 30/0207

(57) ABSTRACT

A method, system, and computer program product for promotional offer spend management. A computer implementation commences upon performing calculations to predict future market response of presenting a particular offer to an audience. The prediction calculations include machine-learning processing of historical offer specification parameters that at least partially characterize the offer. The offer specification comprises a unique combination of parameters and respective media channels, which combination was not measured as pertains to that particular specific unique combination. A predicted market response to the unique offer delivered being over selected media channels is forecasted by using a predictive model.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The disclosure relates to the field of promotional offer spend management and more particularly to techniques for optimizing promotional offer mixes using predictive modeling.

### BACKGROUND

Modern marketing campaigns involve numerous combinations of messages delivered across multiple media channels. Such media channels can include digital or “online” channels (e.g., display, search, email, etc.), and non-digital or “offline” channels (e.g., TV, radio, print, etc.). Professional marketing managers are often responsible for allocating many millions of dollars to media spending across and within such channels, and their performance in that capacity is often measured by one or another forms of measured responses (e.g., conversions) associated with the campaign stimulus (e.g., messages). For both online channels and offline channels, Internet and computing technology has enabled efficient collection of massive amounts of channel-level data and user-level data describing the stimuli and responses associated with a campaign such that a relationship between the stimuli and responses can be characterized in an attribution model.

Unfortunately, legacy attribution models and their usage fail to aid the marketing manager in predicting the effectiveness of a mix of existing and/or newly created promotional offers. Therefore, there is a need for improvements.

### SUMMARY

The present disclosure provides an improved method, system, and computer program product suited to address the aforementioned issues with legacy approaches. More specifically, the present disclosure provides a detailed description of techniques used in methods, systems, and computer program products for optimizing promotional offer mixes using predictive modeling. The disclosed embodiments modify and improve over legacy approaches. In particular, the herein-disclosed techniques provide technical solutions that address the technical problems attendant to managing promotional offer mixes when using predictive modeling.

Such technical solutions serve to reduce the demand for computer memory, reduce the demand for computer processing power, and reduce the demand for inter-component communication. Some embodiments disclosed herein use techniques to improve the functioning of multiple systems within the disclosed environments, and some embodiments advance peripheral technical fields as well.

Further details of aspects, objectives, and advantages of the disclosure are described below and in the detailed description, drawings, and claims. Both the foregoing general description of the background and the following detailed description are exemplary and explanatory, and are not intended to be limiting as to the scope of the claims.

### BRIEF DESCRIPTION OF THE DRAWINGS

FIG. 1A depicts techniques for optimizing promotional offer mixes using predictive modeling, according to some embodiments.

FIG. 1B presents an environment in which embodiments of the present disclosure can operate.

FIG. 2A presents a stimulus attribution predictive modeling technique used in systems for optimizing promotional offer mixes using predictive modeling, according to some embodiments.

FIG. 2B presents a diagram illustrating historical and planned offer mixes for a marketing campaign.

FIG. 3 presents an offer specification parameter mapping technique used in systems for optimizing promotional offer mixes using predictive modeling, according to some embodiments.

FIG. 4A depicts a subsystem for optimizing offer mixes using predictive modeling, according to some embodiments.

FIG. 4B is a flowchart depicting a flow of operations performed in systems for optimizing promotional offer mixes using predictive modeling, according to some embodiments.

FIG. 5A depicts a user interface home page used in the creation and management of offers and offer mixes in systems for optimizing promotional offer mixes using predictive modeling, according to some embodiments.

FIG. 5B depicts an offer mix selection view window rendered by a user interface for creating and managing offers and offer mixes in systems for optimizing promotional offer mixes using predictive modeling, according to some embodiments.

FIG. 5C depicts a new offer creation view window rendered by a user interface for creating and managing offers and offer mixes in systems tsar optimizing promotional offer mixes using predictive modeling, according to some embodiments.

FIG. 5D depicts a new offer selection view window rendered by a user interface for creating and managing offers and offer mixes in systems for optimizing promotional offer mixes using predictive modeling, according to some embodiments.

FIG. 5E depicts an offer mix performance view window in a user interface created for creating and managing offers and offer mixes in systems for optimizing promotional offer mixes using predictive modeling, according to some embodiments.

FIG. 5F depicts an offer mix scenario planning view window within a user interface for creating and managing offers and offer mixes in systems for optimizing promotional offer mixes using predictive modeling, according to some embodiments.

FIG. 6A and FIG. 6B are block diagrams of systems for optimizing promotional offer mixes using predictive modeling, according to some embodiments.

FIG. 7A, and FIG. 7B depict block diagrams of computer system components suitable for implementing embodiments of the present disclosure.

### DETAILED DESCRIPTION

### Overview

Modern marketing campaigns involve numerous combinations of marketing messages delivered across multiple media channels. Such media channels can include digital or “online” channels (e.g., display, search, email, etc.), as well as non-digital or “offline” channels (e.g., TV, radio, print, etc.). Internet and computing technology has enabled efficient collection of massive amounts of channel-level data and user-level data describing the stimuli and responses associated with marketing messages in a marketing campaign. Relationships between the stimuli (e.g., broadcasting, messaging, etc.) and responses (e.g., user clicks, user actions, conversions, etc.) can be characterized in an attribution model. Often, an attribution model is based on historical data collected from the Internet and other data sources, and can account for seasonality, cross-channel effects, and other effects on audience responses to marketing stimuli. These attribution models can be used by the marketing manager to predict the response to a future campaign. Unfortunately, attribution models based on historical data are limited at least in their ability to predict the response to one or more new stimuli and/or unique combinations of stimuli (e.g., unique combinations of stimuli that were not present in the historical data). For example, a subscription TV provider might want to use an attribution model to predict the response to a promotional offer (e.g., “offer”) having a new and/or unique set of features (e.g., no activation fee+7% off monthly rate+July 1 start date+July 31 end data+ . . . , etc.) not included in the already collected historical stimuli data and associated response data.

Techniques are needed to estimate the effectiveness of a mix of existing and/or newly created promotional offers using a stimulus attribution predictive model derived from historical stimulus and response data. Strictly as one embodiment, a protocol for dynamically exchanging characteristics of offer mixes and applying the characteristics to predictive models for real time performance estimates is described herein. Specifically, the protocol can be executed over the Internet to dynamically map the offer specification parameters for an offer mix to a set of modeled input variables of a stimulus attribution predictive model. The updated stimulus attribution predictive model can then be used to predict the performance of the offer mix. In some embodiments, an estimate of the predicted performance of a set of offers can be generated in real time such that a user (e.g., marketing manager) can select a desired (e.g., higher-performing) offer mix from a set of candidate offer mixes.

### Definitions

Some of the terms used in this description are defined below for easy reference. The presented terms and their respective definitions are not rigidly restricted to these definitions—a term may be further defined by the term's use within this disclosure.
The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.
As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances.
The articles “a” and “an” as used in this application and the appended claims should generally be construed to mean “one or more” unless specified otherwise or is clear from the context to be directed to a singular form.

### Solutions Rooted in Technology

The appended figures corresponding to the discussion given herein provides sufficient disclosure to make and use systems, methods, and computer program products that address the aforementioned issues with legacy approaches. More specifically, the present disclosure provides a detailed description of techniques used in systems, methods, and in computer program products for optimizing promotional offer mixes using predictive modeling. Certain embodiments are directed to technological solutions for mapping offer specification parameters for a set of offers to the input variables of a stimulus attribution predictive model, which can in turn be used to estimate the performance of the offers in real time such that a user (e.g., marketing manager) can select an offer mix.

Reference is now made in detail to certain embodiments. The disclosed embodiments are not intended to be limiting of the claims.

### DESCRIPTIONS OF EXEMPLARY EMBODIMENTS

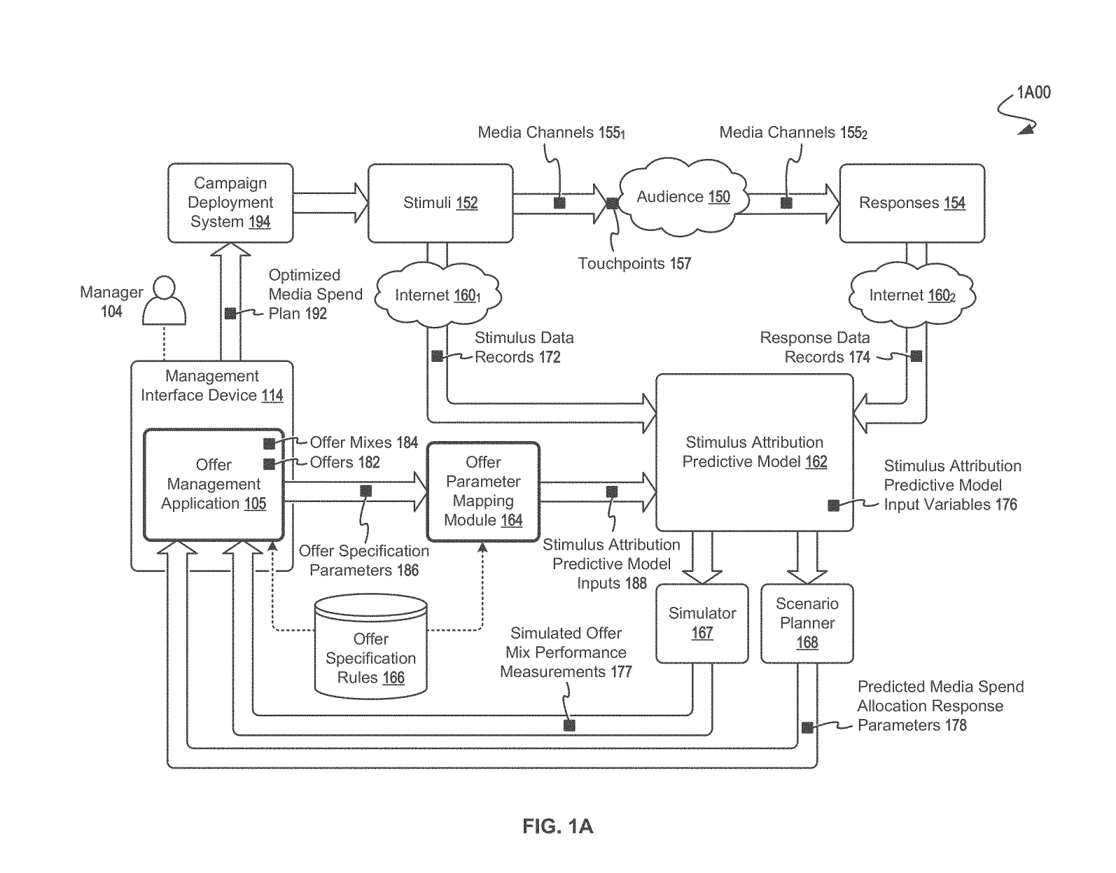

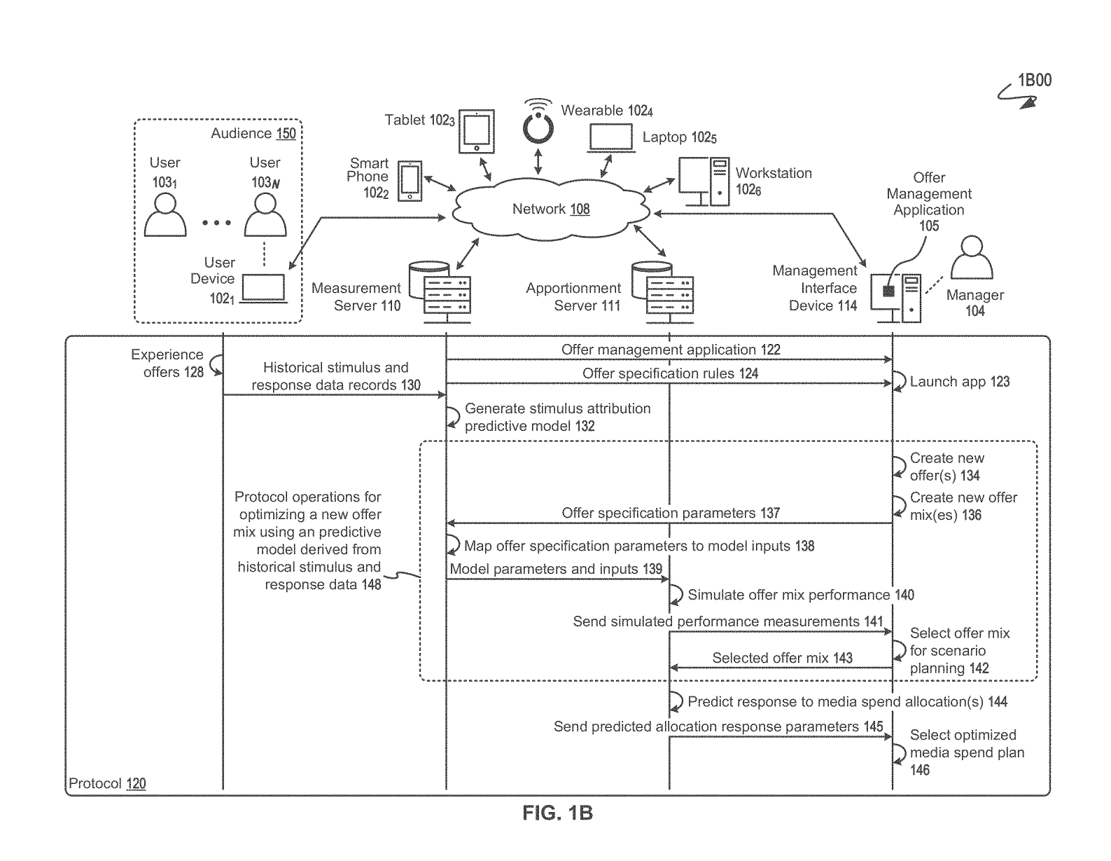

FIG. 1A depicts techniques 1A00 for optimizing promotional offer mixes using predictive modeling. As an option, one or more instances of techniques 1A00 or any aspect thereof may be implemented in the context of the architecture and functionality of the embodiments described herein. Also, the techniques 1A00 or any aspect thereof may be implemented in any desired environment.

As shown in FIG. 1A, a set of stimuli 152 is presented to an audience 150 (e.g., as part of a marketing campaign) that further produces a set of responses 154. For example, the stimuli 152 might be part of a marketing campaign developed by a marketing manager (e.g., manager 104) to reach the audience 150 with the objective to generate user conversions (e.g., sales of a certain product). The stimuli 152 is delivered to the audience 150 through certain instances of media channels 155₁ that can comprise digital or online media channels (e.g., online display, online search, paid social media, email, etc.). The media channels 155₁ can further comprise non-digital or offline media channels (e.g., TV, radio, print, etc.). The audience 150 is exposed to each stimulation comprising the stimuli 152 through a set of touchpoint encounters (e.g., touchpoints 157) characterized by certain respective attributes. The responses 154 can also be delivered through other instances of media channels 155₂ that can further comprise online and offline media channels. In some cases, the information indicating a particular response can be included in the attribute data associated with the instance of the touchpoint encounter to which the user is responding.

Certain aspects in some embodiments of the present application are related to material disclosed in U.S. patent application Ser. No. 13/492,493, now U.S. Pat. No. 9,183,562 entitled “METHOD AND SYSTEM FOR DETERMINING TOUCHPOINT ATTRIBUTION”, filed on Jun. 8, 2012, the content of which is incorporated by reference in its entirety in this Application.

The portion of stimuli 152 delivered through online media channels can be received by the users comprising audience 150 at various instances of user devices (e.g., mobile phone, laptop computer, desktop computer, tablet, etc.). Further, the portion of responses 154 received through digital media channels can be precipitated by users comprising audience 150 using the user devices.

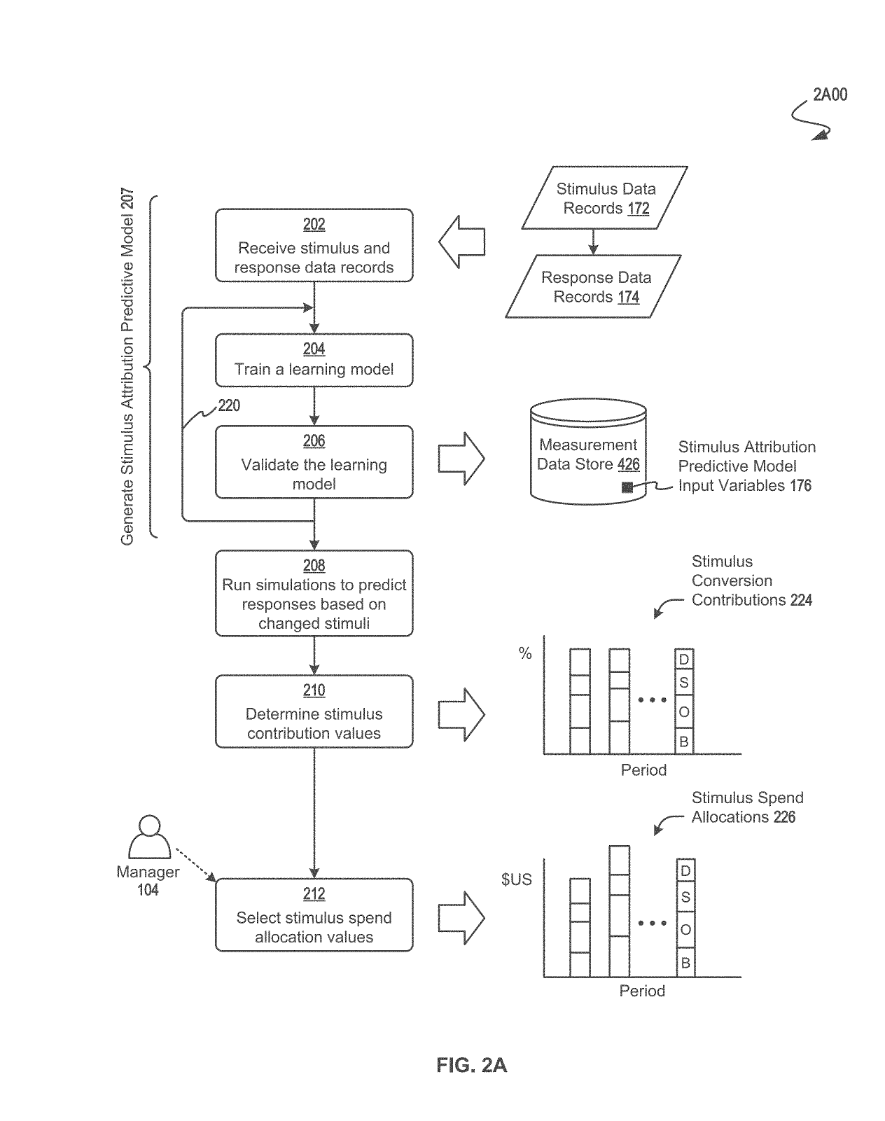

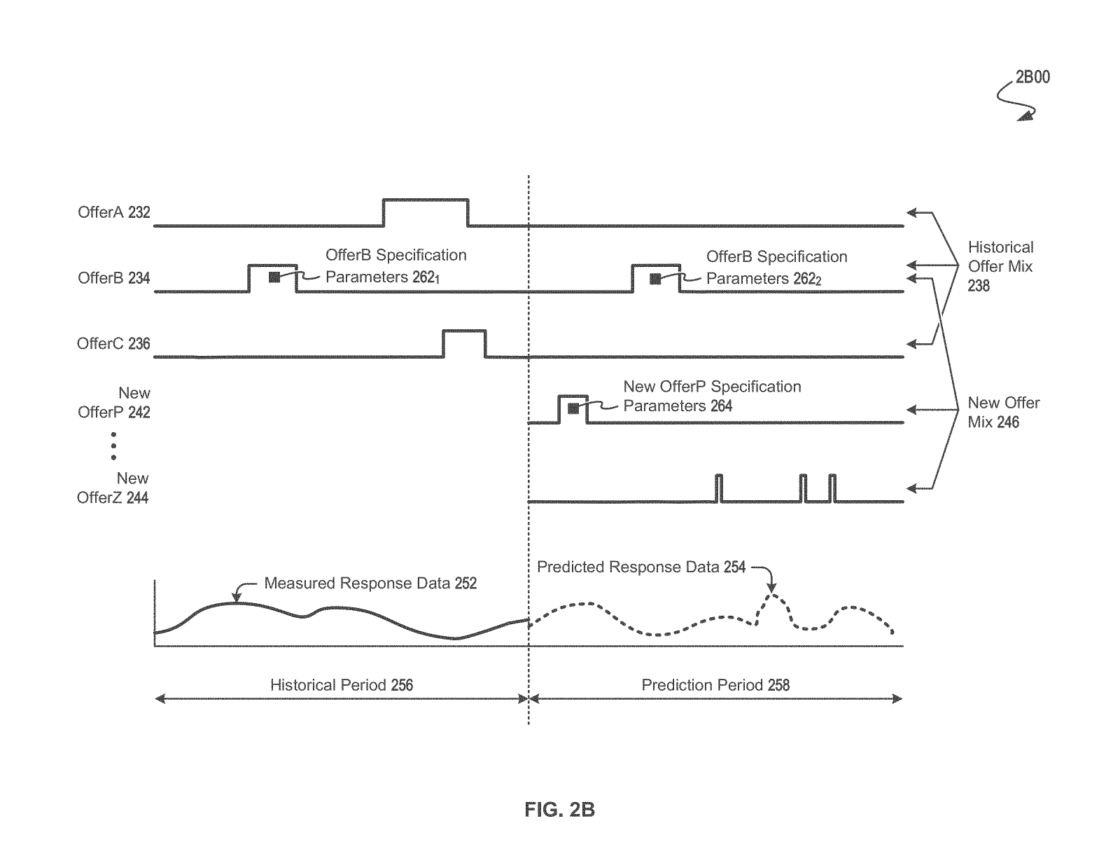

As shown, a set of stimulus data records 172 and a set of response data records 174 can be received over a network (e.g., Internet 160₁ and Internet 160₂, respectively) to be used to generate a stimulus attribution predictive model 162. The stimulus attribution predictive model 162 can be used to estimate the effectiveness of each stimulus in a certain marketing campaign by attributing conversion credit (e.g., contribution value) to the various stimuli comprising the campaign. The stimulus attribution predictive model 162 can be formed using any machine-learning techniques (e.g., see FIG. 2A) to accurately model the relationship between the stimuli 152 and the responses 154. For example, historical summaries of the historical stimuli (e.g., stimulus data records 172) and the historical response (e.g., response data records 174) gathered over a certain historical period (e.g., last six months) can be used to venerate the stimulus attribution predictive model 162. When formed, the stimulus attribution predictive model 162 can be described in part by certain model parameters (e.g., input variables, output variables, equations, equation coefficients, mapping relationships, limits, constraints, etc.), such as the stimulus attribution predictive model input variables 176. A simulator 167 might be used in combination with the stimulus attribution predictive model 162 to estimate the temporal attribution (e.g., contribution value) of each stimulus and/or group of stimuli (e.g., one or more channels from media channels 155₁ and/or one or more channels from media channels 155₂) to the conversions comprising historical response vectors (e.g., response data records 174). For example, the simulator 167 might run a sensitivity analysis on each stimulus comprising the stimulus data records 172 to determine the stimulus attribution. A scenario planner 168 can further use such contribution values and the stimulus attribution predictive model 162 to facilitate selection (e.g., by the manager 104) of a media spend allocation plan for a given marketing campaign.

In some cases, the manager 104 might want to add a new stimulus and/or new group of stimuli (e.g., a new offer and/or a new offer mix, respectively) to a certain marketing campaign, yet without such new stimuli explicitly represented in the historical data. The herein-disclosed techniques provide a technological solution for the manager 104 by mapping the offer specification parameters for a given offer mix to the stimulus attribution predictive model input variables 176 of the stimulus attribution predictive model 162 to estimate future market performance of the offer mix in real time such that the manager 104 can select an optimized offer mix of future marketing messages to be used in a future marketing campaign. Specifically, an offer management application 105 can be provided to the manager 104 for operation on one or more instances of a management interface device 114 (e.g., desktop computer, laptop computer, etc.). The manager 104 can use the offer management application 105 to create and/or manage one or more offers 182, and one or more offer mixes 184. In some cases, certain instances of the offers 182 and/or offer mixes 184 might have been deployed in a historical marketing campaign. In other cases, certain instances of the offers 182 and/or offer mixes 184 may be newly created and/or are yet to be deployed in any marketing campaign. In one or more embodiments, a set of offer specification rules 166 can be used by the manager 104 to create and/or manage the offers 182 in terms associated with the particular business and/or market of the manager 104.

For example, a marketing manager associated with a subscription TV market might want to design a unique offer using specification terms such as “X% off” and “Free Shipping”, yet a marketing manager associated with an automobile dealer market might want to design an offer using specification terms such as “Rebate” and “Financing Rate”. As shown, the offer management application 105 can deliver a set of offer specification parameters 186 describing the instances of the offers 182 and/or offer mixes 184 selected by the manager 104 to an offer parameter mapping module 164. The offer parameter mapping module 164 can map the offer specification parameters 186 to a set of stimulus attribution predictive model inputs 188 that can be interpreted by the stimulus attribution predictive model 162. For example, in one or more embodiments, the stimulus attribution predictive model inputs 186 might correspond to respective instances of the stimulus attribution predictive model input variables 176. In other embodiments, the offer specification rules 166 can be used h the offer parameter mapping module 164 in mapping the offer specification parameters 166 to the stimulus attribution predictive model inputs 188. For example, the offer specification rules 166 might comprise certain relational database tables (e.g., lookup tables), conditional logic (e.g., rules), and other stored data records and/or code that can be used by the offer parameter mapping module 164. In some embodiments, the offer parameter mapping module 164 can use the offer specification rules 166 to perform mapping operations. Strictly as one example, such mapping operations can be used to vary the amplitude of certain inputs such the effectiveness of a mix of existing and/or newly created offers can be considered in combination with inputs derived from a stimulus attribution predictive model. Mapping rules can include specification and parameterization of mapping operations that map (e.g., one-to-one, many-to-few, many-to-many, etc.) from the parameters in a unique combination to the parameters in historical data.

As shown, the herein disclosed techniques enable new instances of the offers 182 and/or new instances of the offer mixes 184 to be interpreted by the stimulus attribution predictive model 162, yet with the stimulus attribution predictive model 162 formed based on historical instances of the stimulus data records 172 and response data records 174. The herein disclosed techniques can further enable the simulator 167 to generate a set of simulated offer mix performance measurements 177. For example, the manager 104 might want to compare various instances of the offer mixes 184. Also, the scenario planner 168 can produce a set of predicted media spend allocation response parameters 178 based in part on the instances of the offers 182 and/or offer mixes 184 selected by the manager 104. For example, the manager 104 might want to compare various spend allocation scenarios among multiple channels in a given campaign and/or among the selected instances of the offers 182 in the selected instance of the offer mixes 184. The simulated offer mix performance measurements 177, the predicted media spend allocation response parameters 178, and other herein disclosed techniques can be used by the manager 104 to select an optimized media spend plan 192 for deployment to the audience 150 by a campaign deployment system 194.

The herein-disclosed technological solution described by the techniques of 1A00 in FIG. 1A can be implemented in various network computing environments and associated online and offline marketplaces. Such an environment is discussed as pertains to FIG. 1B.

FIG. 1B presents an environment 1B00 in which embodiments of the present disclosure can operate. As an option, one or more instances of environment 1B00 or any aspect thereof may be implemented in the context of the architecture and functionality of the embodiments described herein. Also, the environment 1B00 or any aspect thereof may be implemented in any desired environment.

As shown in FIG. 1B the environment 1B00 comprises various computing systems (e.g., servers and devices) interconnected by a network 108. The network 108 can comprise any combination of a wide area network (e.g., WAN), local area network LAN), cellular network, wireless LAN (e.g., WLAN), or any such means for enabling communication of computing systems. The network 108 can also be referred to as the Internet. More specifically, environment 1B00 comprises at least one instance of a measurement server 110, at least one instance of an apportionment server 111 and at least one instance of a management interface device 114. The servers and devices shown in environment 1B00 can represent any single computing system with dedicated hardware and software, multiple computing systems clustered together (e.g., a server farm, a host farm, etc.), a portion of shared resources on one or more computing systems (e.g., a virtual server), or any combination thereof.

The environment 1B00 further comprises at least one instance of a user device 102₁ that can represent one of a variety of other computing devices (e.g., a smart phone 102₂, a tablet 101₃, a wearable 102₄, a laptop 102₅, a workstation 102₆, etc.) having software (e.g., a browser, mobile application, etc.) and hardware (e.g., a graphics processing unit, display, monitor, etc.) capable of processing and displaying information (e.g., web page graphical user interface, etc.) on a display. The user device 102₁ can further communicate information (e.g., web page request, user activity, electronic files, computer files, etc.) over the network 108. The user device 102₁ can be operated by a user 103_{N}. Other users (e.g., user 103₁)—with or without a corresponding user device—can comprise an audience 150. Also, as shown in FIG. 1A, the offer management application 105 can be operating on the management interface device 114 and can be made accessible by the manager 104.

As shown, the user 103₁, the user device 102₁ (e.g., operated by user 103_{N}), the measurement server 110, the apportionment server 111, and the management interface device 114 (e.g., operated by the manager 104) can exhibit a set of high-level interactions (e.g., operations, messages, etc.) in a protocol 120. Specifically, the protocol can represent interactions in systems for optimizing promotional offer mixes using predictive modeling. As shown, the manager 104 can download the offer management application 105 from the measurement server 110 to the management interface device 114 (see message 122) and launch the application (see operation 123). A set of offer specification rules (e.g., offer specification rules 166) can also be made available to the offer management application 105 on the management interface device 114 by the measurement server 110 (see message 124). Users in audience 150 can also experience and interact with various marketing campaign stimuli delivered through certain media channels, such as one or more promotional offers (see operation 128). The users in the audience 150 might take one or more measureable actions in response to such stimuli and/or other non-media effects. Information characterizing the stimuli and responses of the audience 150 during a certain historical period can be collected as historical stimulus data records (e.g., stimulus data records 172) and response data records (e.g., response data records 174) by the measurement server 110 (see message 130). Using the historical stimulus and response data, the measurement server 110 can generate a stimulus attribute predictive model (see operation 132), such as stimulus attribution predictive model 162.

The manager 104 can further use the offer management application 105 on the management interface device 114 to create (see operation 134 and operation 136) one or more new offers (e.g., offers 182) and/or one or more new offer mixes (e.g., offer mixes 184). The offer specification parameters (e.g., offer specification parameters 186) characterizing such offers and/or offer mixes can be sent to the measurement server 110 (see message 137). The measurement server 110 can map (see operation 138) the offer specification parameters to model inputs (e.g., stimulus attribution predictive model inputs 188) that correspond to certain respective input variables of the stimulus attribution predictive model (e.g., stimulus attribution predictive model input variables 176). Such model inputs and other parameters (e.g., coefficients expressions, equations, etc.) characterizing the stimulus attribution predictive model can be transmitted (see message 139) to the apportionment server 111 to simulate (e.g., using simulator 167) offer mix performance (see operation 140) and/or perform other operations. The simulated offer mix performance measurements 177 can be presented to the manager 104 in the offer management application 105 (e.g., see message 141). The manager 104 might then select an offer mix for media spend scenario planning (see operation 142) and send information characterizing the selected mix to the apportionment server 111 (see message 143). A scenario planner 168 on the apportionment server 111 can use the stimulus attribution predictive model and/or other resources to predict the response to certain media spend allocations (see operation 144). The predicted media spend allocation can be forwarded to the management interface device 114 (see message 145) for consideration by the manager 104 to select an optimized media spend plan (see operation 146).

As shown in FIG. 1B, the techniques disclosed herein address the problems attendant to estimating the effectiveness of a mix of existing and/or newly created offers using a stimulus attribution predictive model derived from historical stimulus and response data (see grouping 148).

Certain aspects in some embodiments of the present application are related to material disclosed in U.S. patent application Ser. No. 14/145,625 entitled “MEDIA SPEND OPTIMIZATION USING A CROSS-CHANNEL PREDICTIVE MODEL” (Attorney Docket No. VISQ.P0004) filed on Dec. 31, 2013, the content of which is incorporated by reference in its entirety in this Application.

FIG. 2A presents a stimulus attribution predictive modeling technique 2A00 used in systems for optimizing promotional offer mixes using predictive modeling. As an option, one or more instances of stimulus attribution predictive modeling technique 2A00 or any aspect thereof may be implemented in the context of the architecture and functionality of the embodiments described herein. Also, the stimulus attribution predictive modeling technique 2A00 or any aspect thereof may be implemented in any desired environment.

FIG. 2A depicts process steps (e.g., stimulus attribution predictive modeling technique 2A00) used in the generation of a stimulus attribution predictive model (see grouping 207). As shown, stimulus data records 172 and response data records 174 associated with one or more historical marketing campaigns and/or time periods are received by a computing device and/or system (e.g., measurement server 110) over a network (see step 202). The information associated with the stimulus data records 172 and response data records 174 can be organized into various data structures. A portion of the collected stimulus and response data can be used to train a learning model (see step 204). A different portion of the collected stimulus and response data can be used to validate the learning model (see step 206). The processes of training and validating can be iterated (see path 220) until the learning model behaves within target tolerances (e.g., with respect to predictive statistic metrics, descriptive statistics, significance tests, etc.). In some cases, additional historical stimulus and response data can be collected to further train the learning model (e.g., based on the offer specification parameters 186). When the learning model has been generated, the parameters stimulus attribution predictive model input variables 176) describing the learning model (e.g., stimulus attribution predictive model 162) can be stored in a measurement data store 426 for access by various computing devices (e.g., measurement server 110, management interface device 114, apportionment server 111, etc.)

Specifically, the learning model (e.g., stimulus attribution predictive model 162) might be used to run simulations (e.g., at the apportionment server 111) to predict responses based on changed stimuli (see step 208) such that contribution values for each stimulus and/or group of stimuli can be determined (see step 210). For example, a sensitivity analysis can be performed using the stimulus attribution predictive model 162 to generate a chart showing the stimulus conversion contributions 224 over the studied historical periods. Specifically, a percentage contribution for the stimuli comprising a display channel (“D”), a search channel (“S”), an offline channel (“O”) (e.g., TV), and a base channel (“B”) related to responses not statistically attributable to any such as those related to brand equity) can be determined for each period (e.g., week). Further, a marketing manager (e.g., manager 104) can use the stimulus conversion contributions 224 to further allocate spend among the various media stimuli (e.g., channels “D”, “S”, and “O”) by selecting associated stimulus spend allocation values (see step 212). For example, the manager 104 might apply an overall periodic marketing budget (e.g., in $US) to the various channels according to the relative stimulus contributions presented in the stimulus conversion contributions 224 to produce certain instances of stimulus spend allocations 226 for each analyzed period. In some cases, the stimulus spend allocations 226 can be automatically generated (e.g., recommended) based on the stimulus conversion contributions 224.

FIG. 2B presents a diagram 2B00 illustrating historical and planned offer mixes for a marketing campaign. As an option, one or more instances of diagram 2B00 or any aspect thereof may be implemented in the context of the architecture and functionality of the embodiments described herein. Also, the diagram 2B00 or any aspect thereof may be implemented in any desired environment.

The diagram 2B00 illustrates a time-series visualization of the various stimulus signals and response signals associated with a marketing campaign. Specifically, FIG. 2B depicts a historical offer mix 238 (e.g., OfferA 232, OfferB 234, and OfferC 236) deployed in a historical period 256, and a new offer mix 246 (e.g., OfferB 234, new OfferP 242, and new OfferZ 244) analyzed in a prediction period 258. Further, a set of measured response data 252 is collected in the historical period 256, and a set of predicted response data 254 is estimated for the prediction period 258. As shown, the offers comprising the historical offer mix 238 can be invoked at certain times within the historical period 256 and can have certain durations. Each offer can further have other attributes describing the particular offer. For example, OfferB 234 can be characterized by a set of OfferB specification parameters 262. OfferA 232 and OfferC 236 can further be characterized by a set of respective specification parameters (not shown). Such specification parameters can be used when forming a stimulus attribution predictive model (e.g., stimulus attribution predictive model 162) that models the relationship between the measured response data 252 and the historical offer mix 238. For example, in one or more embodiments, the input variables for the stimulus attribution predictive model can be based in part on the offer specification parameters of the historical offer mix 238.

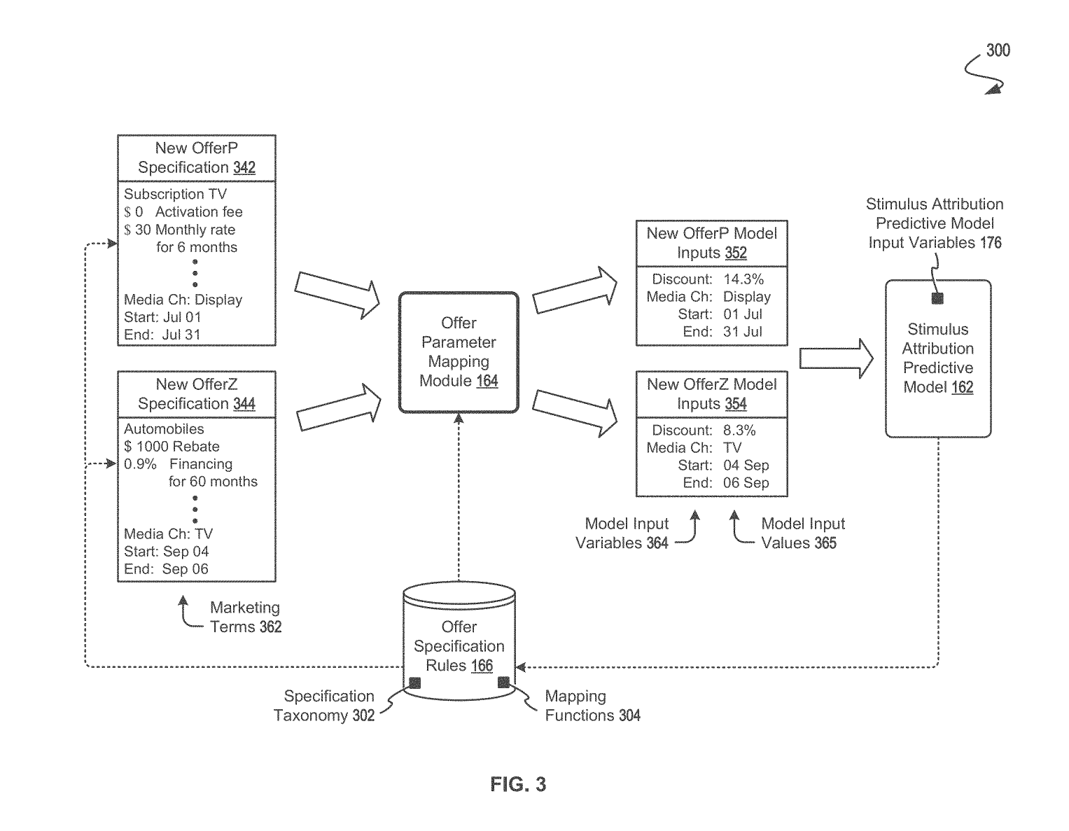

When developing a new marketing campaign, the marketing manager might want to use the stimulus attribution predictive model generated from the historical data (e.g., historical offer mix 238, measured response data 252) collected during the historical period 256 to predict the response (e.g., predicted response data 254) of a particular offer mix (e.g., new offer mix 246) in the prediction period 258 (e.g., next six months). As shown, an existing offer, such as OfferB 234, might be included in the new offer mix 246. In such cases, the OfferB specification parameters 262₂ for OfferB 234 in the prediction period 258 might correspond to the OfferB specification parameters 261 for OfferB 234 in the historical period 256 such that the OfferB specification parameters 262₂ can be interpreted by the stimulus attribution predictive model to estimate the effect of OfferB 234 on the predicted response data 254. In other cases, as shown, one or more new offers (e.g., new OfferP 242, new OfferZ 244) might be included in the new offer mix 246. In such cases, the specification parameters of the new offers (e.g., new OfferP specification parameters 264) might not directly correspond to the input variables for the stimulus attribution predictive model, since such input variables can be based in part on the offer specification parameters of the historical offer mix 233. In such cases, any one or more of the technological solutions provided by the herein disclosed techniques can be implemented. One embodiment of such an implementation is described in more detail in FIG. 3.

FIG. 3 presents an offer specification parameter mapping technique 300 used in systems for optimizing promotional offer mixes using predictive modeling. As an option, one or more instances of offer specification parameter mapping technique 300 or any aspect thereof may be implemented in the context of the architecture and functionality of the embodiments described herein. Also, the offer specification parameter mapping technique 300 or any aspect thereof may be implemented in any desired environment.

The offer specification parameter mapping technique 300 shown in FIG. 3 illustrates one implementation of a technique for mapping offer specifications to model inputs such the effectiveness of a mix of existing and/or newly created offers can be determined using a stimulus attribution predictive model derived from historical stimulus and response data. Specifically, a new OfferP specification 342 and a new OfferZ specification 344 are shown. The new OfferP specification 342 might represent a new offer designed for the subscription TV market having a $0 activation fee and a $30 monthly rate for 6 months, to be delivered through an online display media channel for the month of July. As indicated, the new OfferP specification 342 might comprise other attributes. Further, the new OfferZ specification 344 might represent a new offer designed for the automobile sales market having a $1000 rebate and 0.9% financing for 60 months, to be delivered through a TV media channel over Labor Day weekend. As shown, the new OfferZ specification 344 might comprise other attributes.

As earlier described, in some cases, the new OfferP specification 342 and/or the new OfferZ specification 344 might be a unique combination of parameters that is unique at least as compared to combinations of parameters of the historical offers included in the corpus of historical stimulus and response data that was used to generate the stimulus attribution predictive model 162. In such cases, the shown offer specification parameter mapping technique 300 can be implemented to allow use of the stimulus attribution predictive model 162 for selecting optimized offer mixes and/or optimized media spend allocations. Specifically, the new OfferP specification 342 and/or the new OfferZ specification 344 can be processed by the offer parameter mapping module 164 to produce the new OfferP model inputs 352 and the new OfferZ model inputs 354, respectively. More specifically, the offer parameter mapping module 164 can interpret various offer specifications expressed in a set of marketing terms 362 to transform the offer specifications to pairs (e.g., key-value pairs) of model input variables 364 and respective instances of model input values 365. For example, the new OfferP specification 342 might be transformed by the offer parameter mapping module 164 to the variable-value pairs shown in the new OfferP model inputs 352.

As another example, the new OfferZ specification 344 might be transformed by the offer parameter mapping module 164 to the variable-value pairs shown in the new OfferZ model inputs 354. As shown, the model input variables 364 (e.g., “Discount”, “Media Ch”, “Start”, and “End”) comprising the new OfferP model inputs 352 and the new OfferZ model inputs 354 can correspond to the stimulus attribution predictive model input variables 176 modeled in the stimulus attribution predictive model 162 such that the stimulus attribution predictive model 162 can be used to estimate the performance of the new unique offers. In some embodiments, the offer parameter mapping module 164 can use the offer specification rules 166 to perform the mapping operation. Specifically, the stimulus attribution predictive model input variables 176 can be used in part to create a set of mapping functions 304 and/or a specification taxonomy 302. For example, the specification taxonomy 302 might be used to determine the marketing terms 362 that the marketing manager can use such that the mapping functions 304 can be used by the offer parameter mapping module 164 to produce the model input variables 364 and the model input values 365.

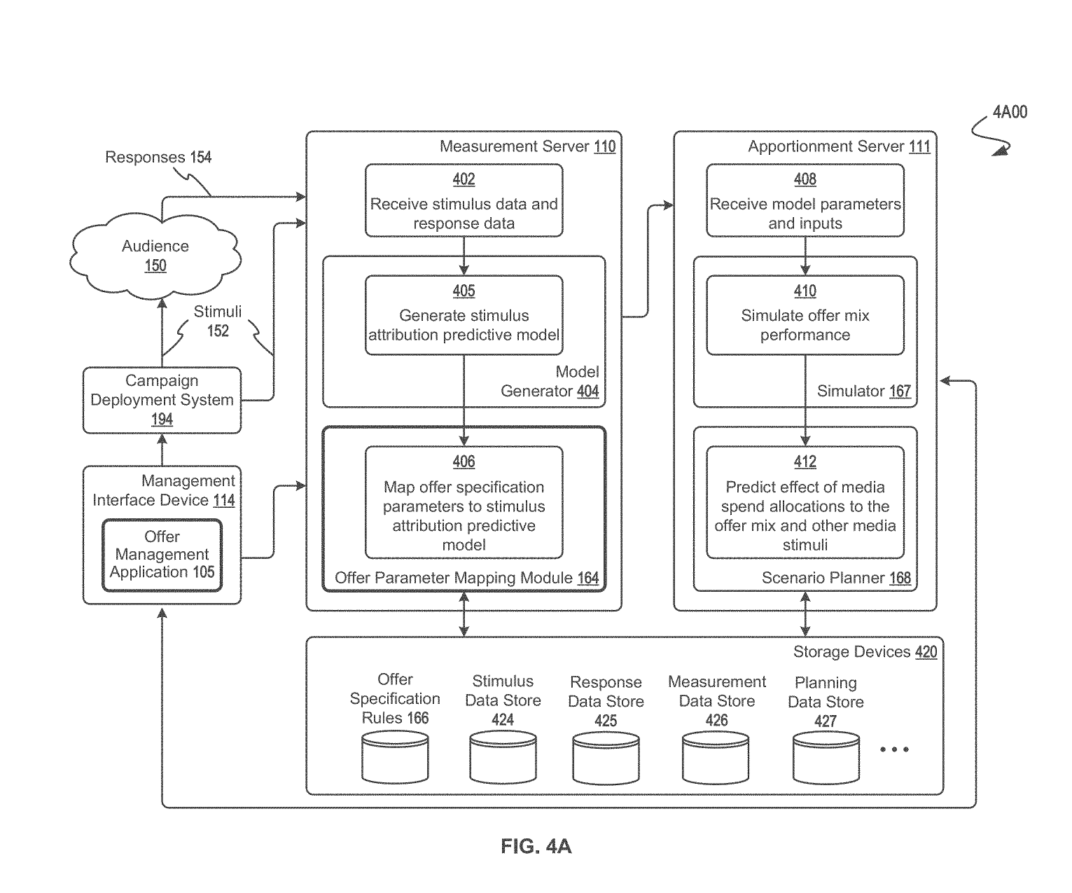

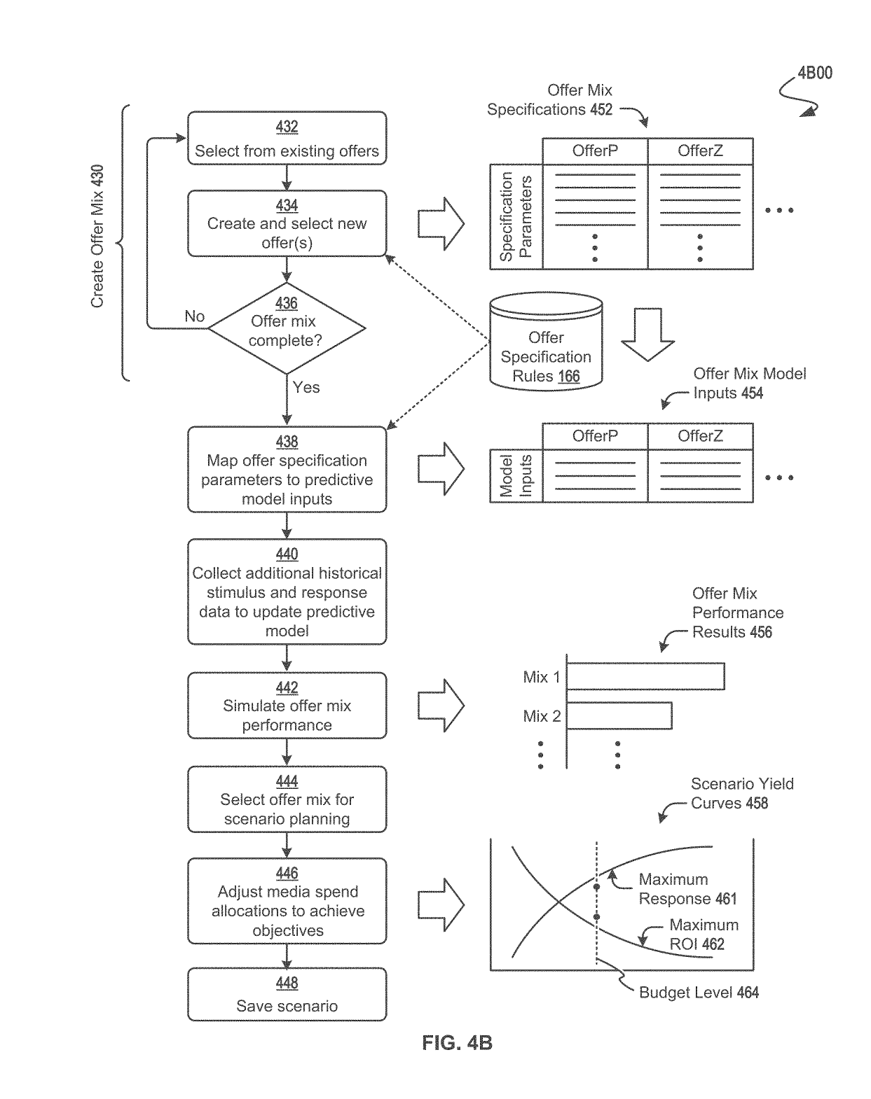

One embodiment of a subsystem for implementing the offer specification parameter mapping technique 300 and/or other herein disclosed techniques is discussed as pertains to FIG. 4A.

FIG. 4A depicts a subsystem 4A00 for optimizing promotional offer mixes using predictive modeling. As an option, one or more instances of subsystem 4A00 or any aspect thereof may be implemented in the context of the architecture and functionality of the embodiments described herein. Also, the subsystem 4A00 or any aspect thereof may be implemented in any desired environment.

As shown, subsystem 4A00 comprises certain components described in FIG. 1A. Specifically, the campaign deployment system 194 can present the stimuli 152 to the audience 150 to produce the responses 154. The measurement server 110 can receive electronic data records associated with the stimuli 152 and responses 154 (see operation 402). The stimulus data and response data can be stored in one or more storage devices 420 (e.g., stimulus data store 424, response data store 425, etc.). The measurement server 110 further comprises a model generator 404 that can use the stimulus data, response data, and/or other data to generate the stimulus attribution predictive model (see operation 405). In some embodiments, the model parameters (e.g., stimulus attribution predictive model input variables 176) characterizing the stimulus attribution predictive model 162 can be stored in the measurement data store 426. The offer parameter mapping module 164 operating on the measurement server 110 can map offer specification parameters to the input variables of the stimulus attribution predictive model 162 (see operation 406). In some embodiments, such offer specification parameters can be received from the offer management application 105 operating on the management interface device 114. Further, the offer parameter mapping module 164 might use various data (e.g., mapping functions, taxonomies, etc.) stored in the offer specification rules 166 in performing mapping operations and/or other operations.

As shown, the apportionment server 111 can receive the model parameters and model inputs from the model generator 404 and/or the offer parameter mapping module 164 in the measurement server 110 (see operation 408) to enable the simulator 167 to simulate the performance of certain specified instances of offer mixes (see operation 410). The scenario planner 168 on the apportionment server 111 can further use the model parameters, the model inputs, the simulated offer mix performance, and/or other data to predict the effect of relative media spend allocations to certain offer mixes and/or other media stimuli (see operation 412) such as various online and/or offline media channels. In one or more embodiments, a user (e.g., marketing manager) can interface with the offer management application 105 to interact with the simulator 167 and/or the scenario planner 168 to select an optimized offer mix and/or select an optimized media spend plan.

The subsystem 4A00 presents merely one partitioning. The specific example shown where the measurement server 110 comprises the model generator 404 and the offer parameter mapping module 164, and where the apportionment server 111 comprises the simulator 167 and the scenario planner 168, is purely exemplary and other partitioning is reasonable. Partitioning may be defined in part by the volume of empirical data and/or the volume and location of planning data store 427. In some cases, a database engine can serve to perform calculations (e.g., within, or in conjunction with, a database engine query). A technique for optimizing promotional offer mixes using predictive modeling implemented in such systems, subsystems, and using various partitioning is shown in FIG. 4B.

FIG. 4B is a flowchart 4B00 depicting a flow of operations performed in systems for optimizing promotional offer mixes using predictive modeling. As an option, one or more instances of flowchart 4B00 or any aspect thereof may be implemented in the context of the architecture and functionality of the embodiments described herein. Also, the flowchart 4B00 or any aspect thereof may be implemented in any desired environment.

The flowchart 4B00 presents one embodiment of certain steps for optimizing promotional offer mixes using predictive modeling. In one or more embodiments, the steps and underlying operations shown in the flowchart 4B00 can be executed by the measurement server 110 and apportionment server disclosed herein. As shown, the flowchart 4B00 can commence with a set of steps for creating an offer mix (see grouping 430). Specifically, an offer mix might be created by selecting from certain existing offers (see step 432) and/or creating and selecting one or more new offers (see step 434). In some cases, the specifications characterizing new offers can be based in part on the offer specification rules 166. When the offer mix selection is complete (see decision 436), a set of offer mix specifications 452 can be identified,

The offer mix specifications 452 can then be mapped to a set of model inputs corresponding to the input variables of a stimulus attribution predictive model (see step 438). For example, a set of offer mix model inputs 454 can be generated such that the stimulus attribution predictive model can estimate the effectiveness and/or performance of the offer mix. Certain data and/or code stored in the offer specification rules 166 can be used to perform such mapping. In some cases, the offer mix model inputs 454 derived from the offer mix specifications 452 can invoke the collection of additional historical stimulus and response data to update the stimulus attribution predictive model (see step 440). For example, the offer mix model inputs 454 might comprise a new input associated with a variable that has not been modeled by the stimulus attribution predictive model. In such cases, additional stimulus data records and/or additional response data records can be identified and collected to generate an updated stimulus attribution predictive model that can interpret the new input.

The performance of the specified offer mix can be simulated based in part on the stimulus attribution predictive model (e.g., existing and/or updated) and the offer mix model inputs 454 (see step 442). For example, the simulation might produce a set of offer mix performance results 456 that can be used to compare various offer mixes and/or other marketing stimuli. The offer mix performance results 456 can be presented using various metrics such as cost, return on investment (ROI), sales, subscriptions, clicks, impressions, and/or other metrics. The offer mix performance results 456 and/or other information can be used to select one or more offer mixes for media spend scenario planning (see step 444). In one or more embodiments, scenario planning can produce the shown example of scenario yield curves 458. Specifically, the scenario yield curves 458 might comprise a curve representing a maximum response 461 and a curve representing a maximum ROI 462. Using the scenario yield curves 458, media spend allocations can be adjusted such that predicted performance can achieve and/or approach a set of objectives (see step 446). For example, a budget level 464 might be associated with a total overall media spend such that the predicted response and predicted ROI for a given scenario might align with the boundary limit of the budget level 464 as shown. The scenario can be saved for immediate and/or future deployment (see step 448).

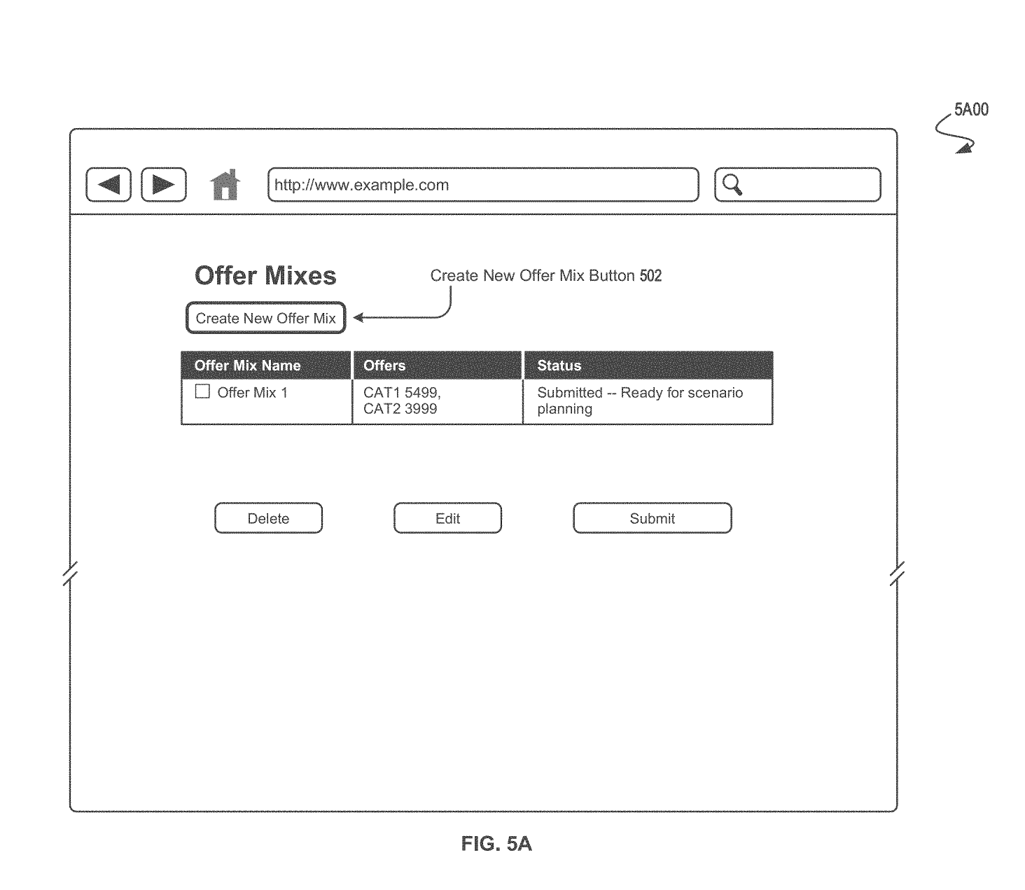

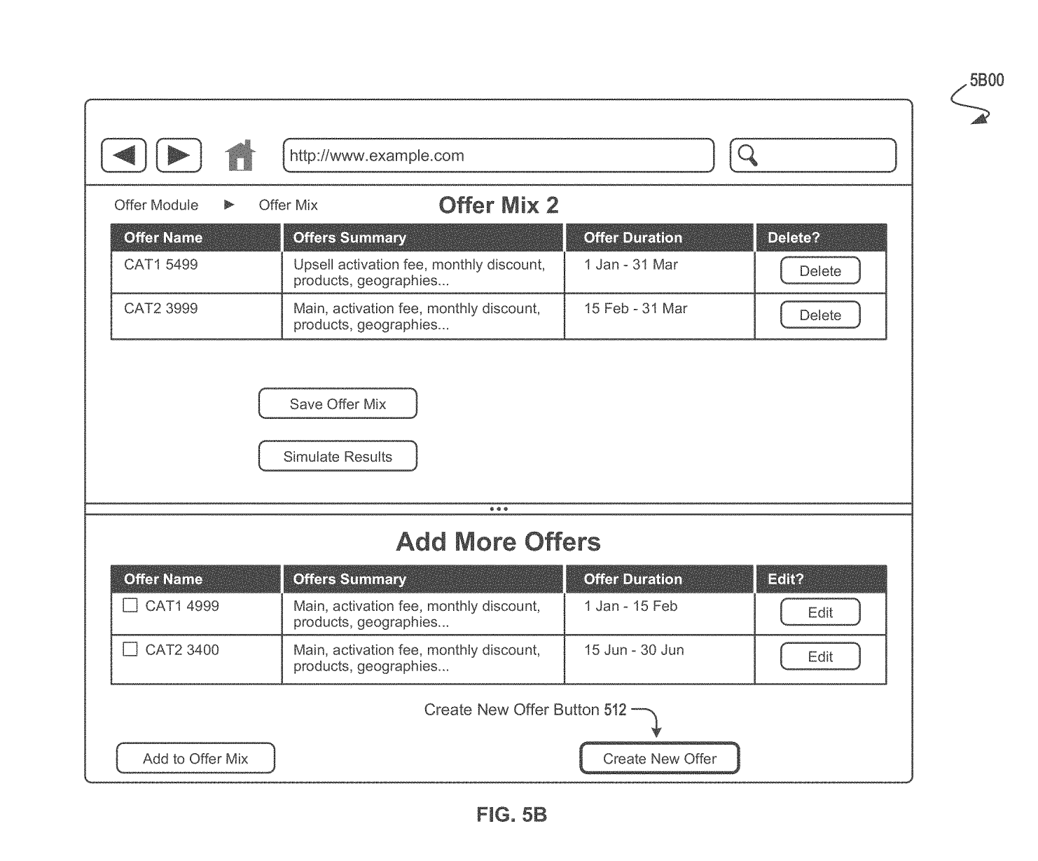

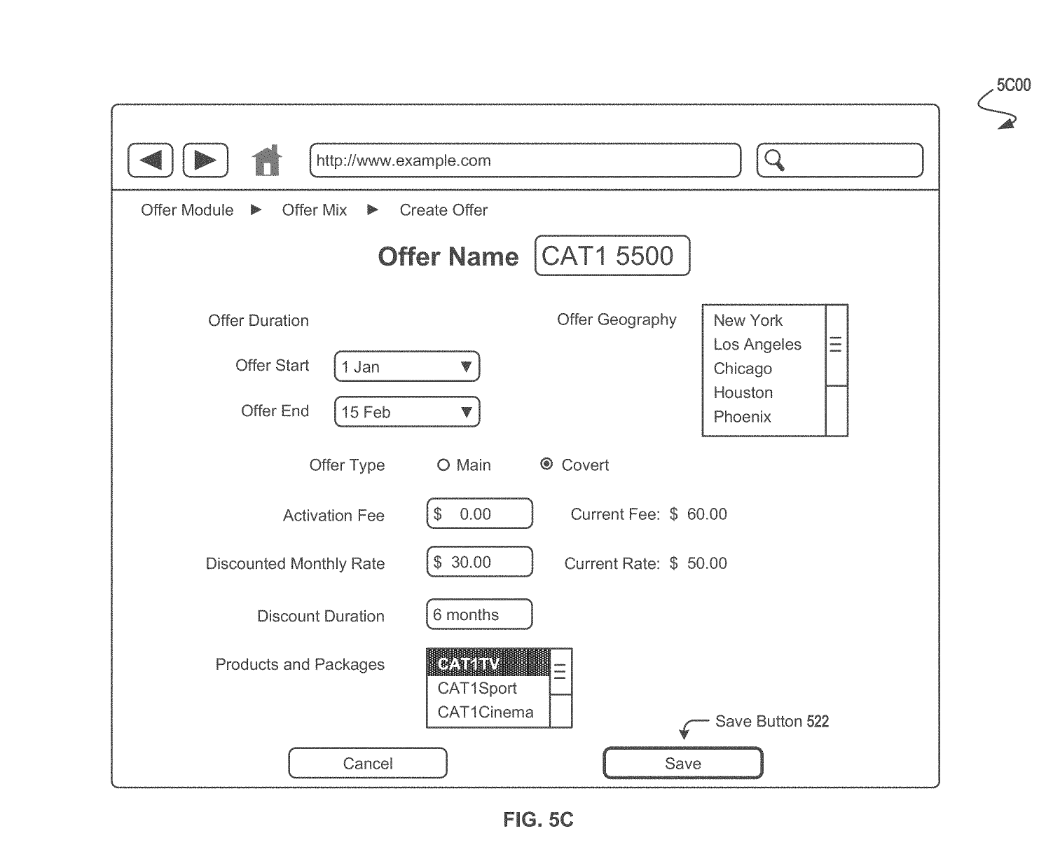

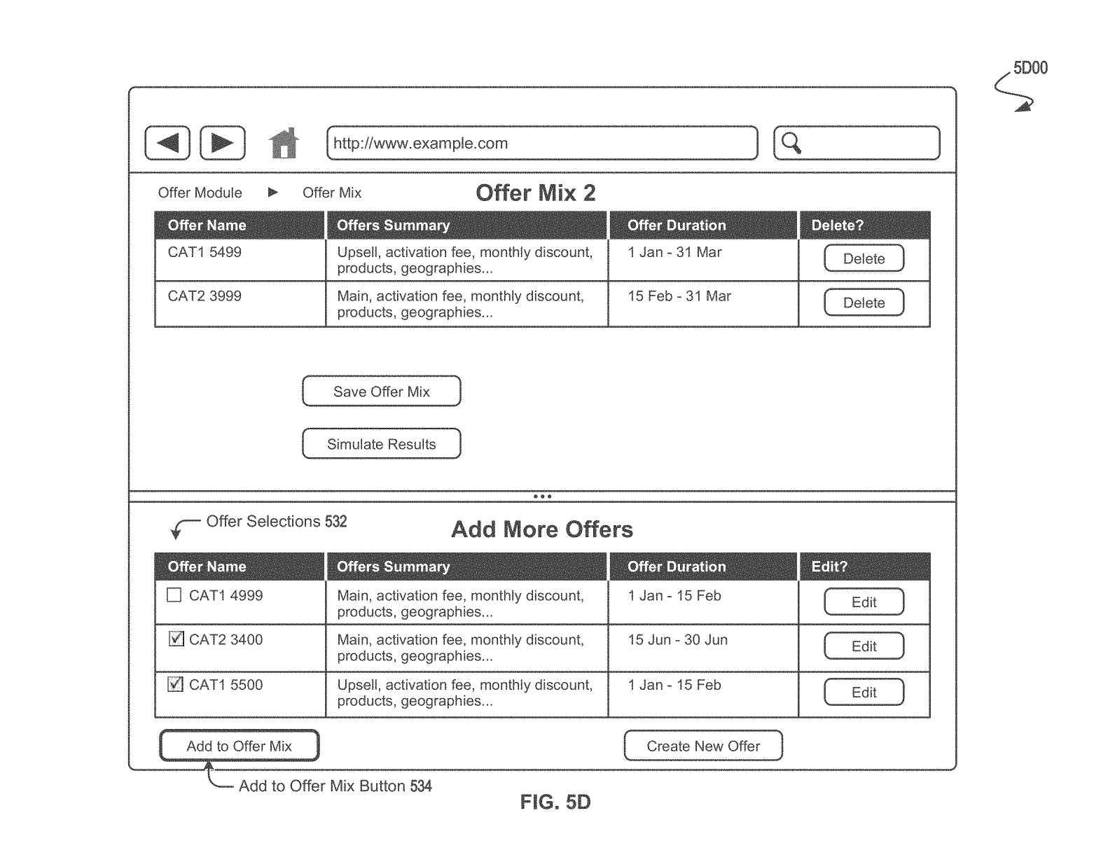

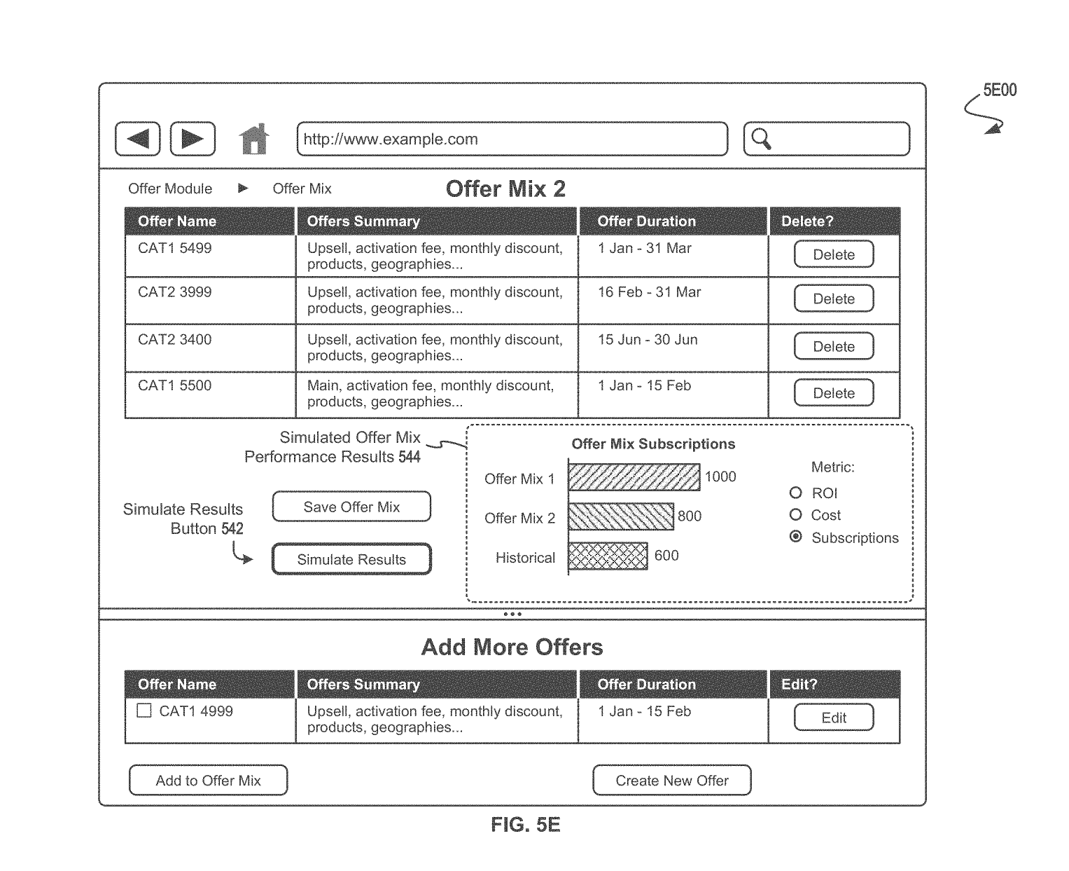

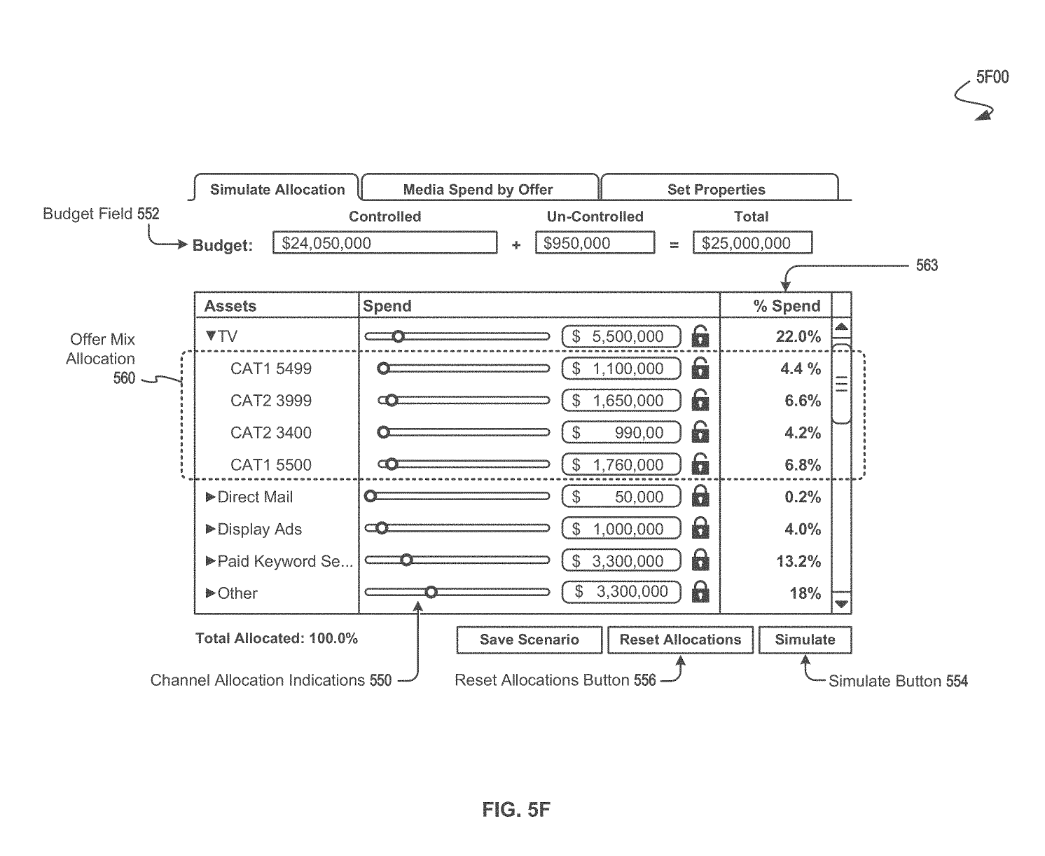

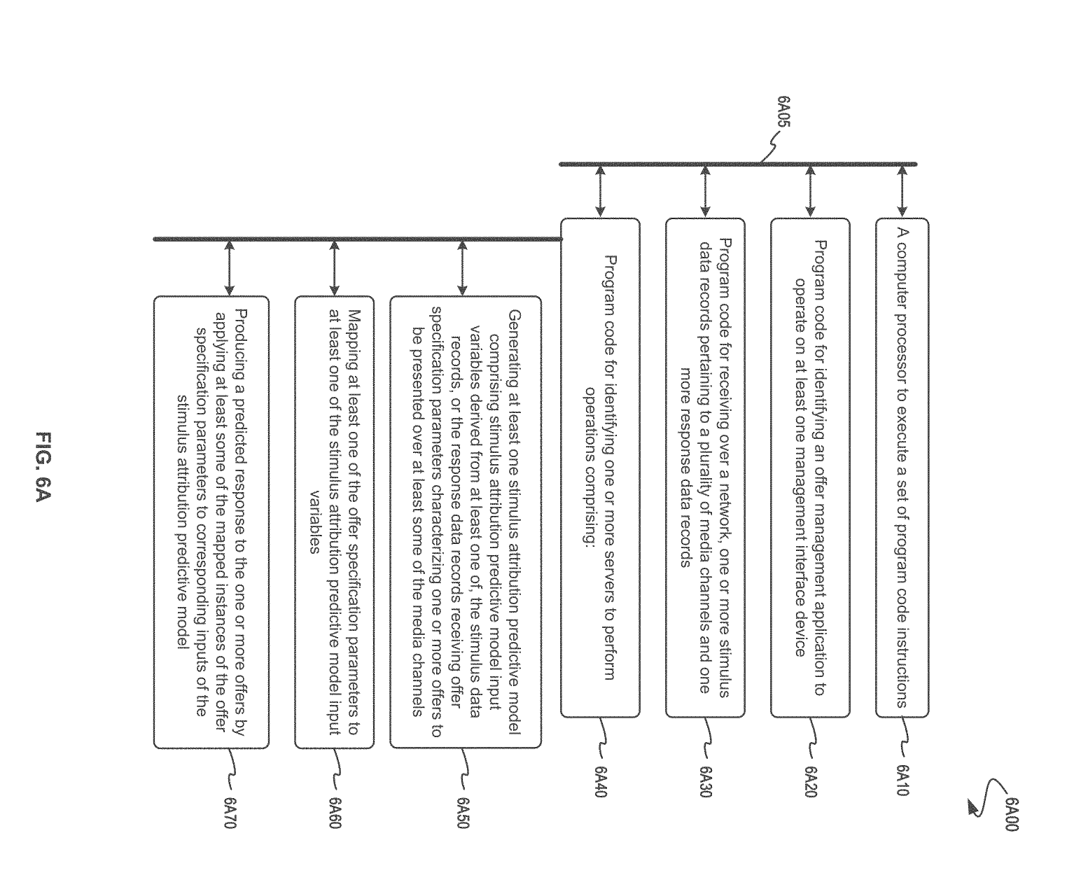

Embodiments of a user interface to enable a user (e.g., marketing manager) to interact with the herein disclosed techniques and subsystems are described in FIG. 5A through FIG. 5F.

FIG. 5A depicts a user interface home page 5A00 used in the creation and management of offers and offer mixes in systems for optimizing promotional offer mixes using predictive modeling. As an option, one or more instances of user interface home page 5A00 or any aspect thereof may be implemented in the context of the architecture and functionality of the embodiments described herein. Also, the user interface home page 5A00 or any aspect thereof may be implemented in any desired environment.

On the shown user interface home page 5A00, the marketing manager can manage one or more offer mixes. Specifically, the marketing manager can create, edit, delete, and/or submit the offer mixes listed for scenario planning. When the create new offer mix button is clicked see create new offer mix button 502) is clicked, the view window shown in FIG. 5B can be invoked for display.

FIG. 5B depicts an offer mix selection view window 5B00 rendered by a user interface for creating and managing offers and offer mixes in systems for optimizing promotional offer mixes using predictive modeling. As an option, one or more instances of offer mix selection view window 5B00 or any aspect thereof may be implemented in the context of the architecture and functionality of the embodiments described herein. Also, the offer mix selection view window 5B00 or any aspect thereof may be implemented in any desired environment.

The marketing manager can use the offer mix selection view window 5B00 to create a new offer mix named “Offer Mix 2”. The new offer mix can be initially populated with the offers (e.g., “CAT1 5499”, “CAT2 3999”) from the most recently created offer mix. The marketing manager can manage the contents of the offer mix by deleting included offers and/or selecting and adding existing offers (e.g., “CAT1 4999”, “CAT2 3400”). To create a new offer to be added to the offer mix, the marketing manager can click the shown create new offer button 512 to invoke the view window shown in FIG. 5C.

FIG. 5C depicts a new offer creation view window 5C00 rendered by a user interface for creating and managing offers and offer mixes in systems for optimizing promotional offer mixes using predictive modeling. As an option, one or more instances of new offer creation view window 5C00 or any aspect thereof may be implemented in the context of the architecture and functionality of the embodiments described herein. Also, the new offer creation view window 5C00 or any aspect thereof may be implemented in any desired environment.

In the new offer creation view window 5C00, the marketing manager can create offers based on the parameters available. Specifically, in one or more embodiments, the displayed offer specification parameters can be generated from the offer specification rules 166, such that the offer specifications can be mapped to stimulus attribution predictive model input variables according to the herein disclosed techniques. For example, as shown, the new offer named “CAT1 5500” might have specification parameters associated with duration, start, end, geography, type, activation fee, discounted monthly rate, discount duration, products and packages, and/or other parameters. When the marketing manager has specified the parameters for the new offer, a save button 522 can be clicked to return to the view window shown in FIG. 5D.

FIG. 5D depicts a new offer selection view window 5D00 rendered by a user interface for creating and managing offers and offer mixes in systems for optimizing promotional offer mixes using predictive modeling. As an option, one or more instances of new offer selection view window 5D00 or any aspect thereof may be implemented in the context of the architecture and functionality of the embodiments described herein. Also, the new offer selection view window 5D00 or any aspect thereof may be implemented in any desired environment.

In the new offer selection view window 5D00, the marketing manager can select (e.g., see offer selections 532 the newly created offer “CAT1 5500” and the existing offer “CAT2 3400” and add them to “Offer Mix 2” by clicking an add to offer mix button 534. In this case, the view window shown in FIG. 5E can be invoked.

FIG. 5E depicts an offer mix performance view window 5E00 in a user interface for creating and managing offers and offer mixes in systems for optimizing promotional offer mixes using predictive modeling. As an option, one or more instances of offer mix performance view window 5E00 or any aspect thereof may be implemented in the context of the architecture and functionality of the embodiments described herein. Also, the offer mix performance view window 5E00 or any aspect thereof may be implemented in any desired environment.

The offer mix performance view window 5E00 shows the four offers comprising the “Offer Mix 2”. The marketing manager can click a simulate results button 542 to generate a set of simulated offer mix performance results 544. In some cases, as shown, the simulated offer mix performance results 544 can render for viewing by the marketing manager a chart comparing the relative simulated and/or actual performance of various offer mixes and/or other marketing stimuli (e.g., historical offer and/or channel performance). Various possible performance metrics can be presented. For example, as shown in the offer mix performance view window 5E00, a comparison of simulated and/or actual new subscriptions responsive to each corresponding stimulus is presented. As further shown, other metrics (e.g., ROI, cost) can be selected for viewing. When satisfied with a given offer mix, the marketing manager can submit the offer mix (e.g., from the user interface home page 5A00) for scenario planning, as depicted in FIG. 5F.

FIG. 5F depicts an offer mix scenario planning view window 5F00 within a user interface for creating and managing offers and offer mixes in systems for optimizing promotional offer mixes using predictive modeling. As an option, one or more instances of offer mix scenario planning view window 5F00 or any aspect thereof may be implemented in the context of the architecture and functionality of the embodiments described herein. Also, the offer mix scenario planning view window 5F00 or any aspect thereof may be implemented in any desired environment.

The offer mix scenario planning view window 5F00 can be invoked to show default conditions and/or to show the allocations across the channels and/or offers of a given marketing campaign that correspond to stimulus attribution calculations enabled, in part, by the herein disclosed techniques. By interacting with the offer mix scenario planning view window 5F00, a marketing manager (or any user) can reallocate spending over the channels and/or offers in the marketing campaign and view the results (e.g., using simulation, etc.) of such reallocation in real time. Specifically, and as shown, a marketing manager can enter a budget amount using a budget field 552 or by using an associated budget allocation slider. A default value for a budget can be determined via a calculation that chooses a midpoint between a user-defined minimum budget and user-defined maximum budget. Such user-defined budget points can be defined in a different interface view (e.g., the “Set Properties” tab). In some cases, the budget might be “unknown”. In such a case, a default budget is determined. One approach to determining a default budget (e.g., a minimum budget) is to sum all of the minimum spend values as given through the entire media portfolio, and use that value.

Responsive to a change in the budget amount, the system displays an allocation. The allocation can be displayed as a percent of the budget (e.g., using sliders or other display components to show an arrangement of channel allocation indications 550), or the allocation can be displayed in the units of the budget (e.g., in euros). When allocations are established, the marketing manager can invoke activities that perform a simulation by clicking a simulate button 554. Such activities serve to determine or predict the effect that the selected allocations might have on the response of the media portfolio. For example, the predicted effect might be represented in relation to a set of scenario yield curves comprising a maximum response curve and a maximum ROI curve (e.g., see FIG. 4B). In some cases, a user might want to return the selected allocations to the default and/or recommended values. In such a case, the user can interact with a display component to reset allocation (e.g., using reset allocations button 556). Any of a variety of known-in-the art techniques can be used to prevent unwanted overwriting of user values can be employed during user interaction.

As presented by the channel allocation indications 550 and specified in a “% Spend” column 563, certain allocations have been selected at the channel level (e.g., TV=22.0%, Direct Mail=0.2%, Display Ads=4.0%, Paid Keyword Search=13.2% and Other=18%). As described herein, the marketing manager can further use the offer mix scenario planning view window 5F00 to select an offer mix allocation 560. Specifically, the herein disclosed techniques enable the effectiveness of a mix of existing and/or newly created offers to be estimated using a stimulus attribution predictive model, derived from historical stimulus and response data, such that offer mix media spend allocation scenarios can be simulated and planned. For example, as shown, the marketing manager can allocate the channel-level TV media spend to specific offers (e.g., “CAT1 5499”, “CAT2 3999”, “CAT2 3400”, “CAT1 5500”) based in part on the offer mix model inputs mapped from the offer mix specification parameters according to the herein disclosed techniques.

### Additional Practical Application Examples

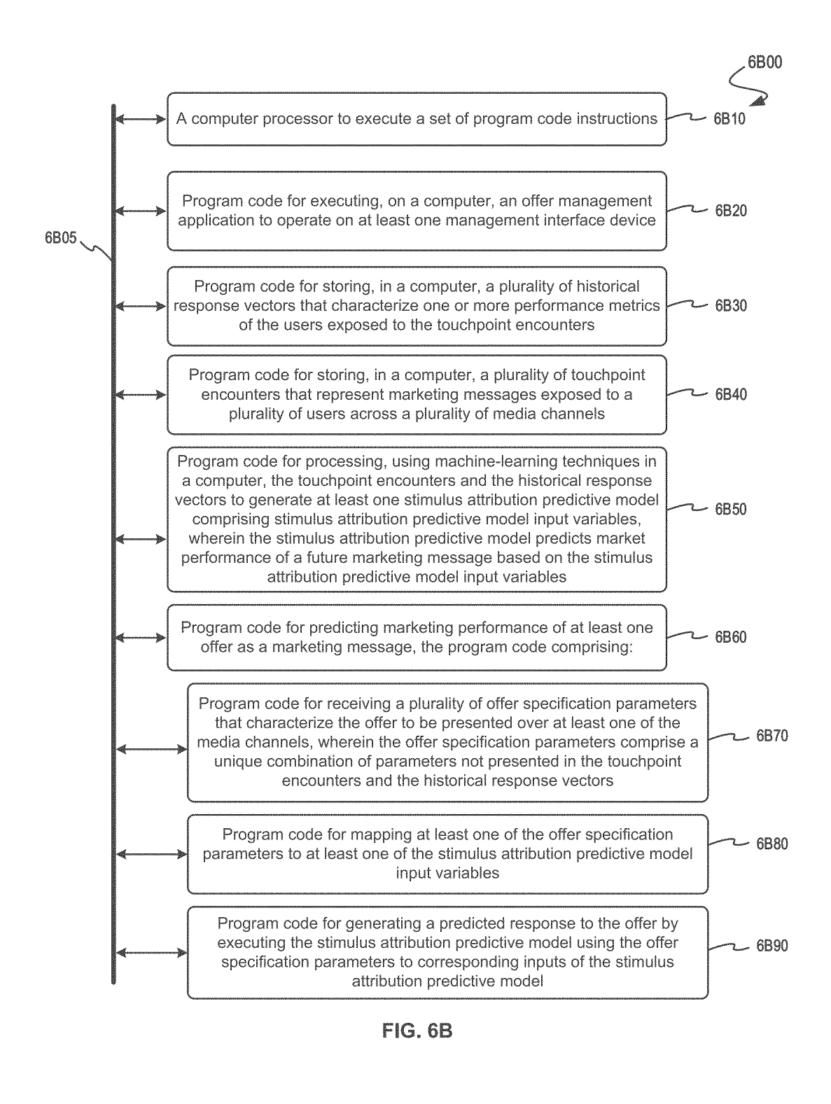

FIG. 6A is a block diagram of a system for optimizing promotional offer mixes using predictive modeling, according to an embodiment. As an option, the present system 6A00 may be implemented in the context of the architecture and functionality of the embodiments described herein. Of course, however, the system 6A00 or any operation therein may be carried out in any desired environment. The system 6A00 comprises at least one processor and at least one memory, the memory serving to store program instructions corresponding to the operations of the system. As shown, an operation can be implemented in whole or in part using program instructions accessible by a module. The modules are connected to a communication path 6A05, and any operation can communicate with other operations over communication path 6A05. The modules of the system can, individually or in combination, perform method operations within system 6A00. Any operations performed within system 6A00 may be performed in any order unless as may be specified in the claims. The shown embodiment implements a portion of a computer system, presented as system 6A00, comprising a computer processor to execute a set of program code instructions (see module 6A10) and modules for accessing memory to hold program code instructions to perform: identifying an offer management application to operate on at least one management interface device (see module 6A20); receiving over a network, one or more stimulus data records pertaining to a plurality of media channels and one more response data records (see module 6A30); identifying one or more servers (see module 6A40) to perform operations comprising:
generating at least one stimulus attribution predictive model comprising stimulus attribution predictive model input variables derived from at least one of, the stimulus data records, or the response data records receiving offer specification parameters characterizing one or more offers to be presented over at least some of the media channels (see module 6A50);
mapping at least one of the offer specification parameters to at least one of the stimulus attribution predictive model input variables (see module 6A60); and
producing a predicted response to the one or more offers by applying at least some of the mapped instances of the offer specification parameters to corresponding inputs of the stimulus attribution predictive model (see module 6A70).

FIG. 6B is a block diagram of a system for optimizing promotional offer mixes using predictive modeling, according to an embodiment. As an option, the present system 6B00 may be implemented in the context of the architecture and functionality of the embodiments described herein. Of course, however, the system 6B00 or any operation therein may be carried out in any desired environment. As an option, the system 6B00 may be implemented in the context of the architecture and functionality of the embodiments described herein. Of course, however, the system 6B00 or any operation therein may be carried out in any desired environment. The system 6B00 comprises at least one processor and at least one memory, the memory serving to store program instructions corresponding to the operations of the system. As shown, an operation can be implemented in whole or in part using program instructions accessible by a module. The modules are connected to a communication path 6B05, and any operation can communicate with other operations over communication path 6B05. The modules of the system can, individually or in combination, perform method operations within system 6B00. Any operations performed within system 6B00 may be performed in an order unless as may be specified in the claims. The shown embodiment implements a portion of a computer system, presented as system 6B00, comprising a computer processor to execute a set of program code instructions (see module 6B10) and modules for accessing memory to hold program code instructions to perform: executing, on a computer, an offer management application to operate on at least one management interface device (see module 6B20); storing, in a computer, a plurality of touchpoint encounters that represent marketing messages exposed to a plurality of users across a plurality of media channels (see module 6B30); storing, in a computer, a plurality of historical response vectors that characterize one or more performance metrics of the users exposed to the touchpoint encounters (see module 6B40); processing, using machine-learning techniques in a computer, the touchpoint encounters and the historical response vectors to generate at least one stimulus attribution predictive model composing stimulus attribution predictive model input variables, wherein the stimulus attribution predictive model predicts market performance of a future marketing message based on the stimulus attribution predictive model input variables (see module 6B50), predicting marketing performance of at least one offer as a marketing message (see module 6B60), wherein the predicting comprises; receiving a plurality of offer specification parameters that characterize the offer to be presented over at least one of the media channels, wherein the offer specification parameters comprise a unique combination of parameters not presented in the touchpoint encounters and the historical response vectors (see module 6B70); mapping at least one of the offer specification parameters to at least one of the stimulus attribution predictive model input variables (see module 6B80); and generating a predicted response to the offer by executing the stimulus attribution predictive model using the offer specification parameters to corresponding inputs of the stimulus attribution predictive model (see module 6B90).

### Additional System Architecture Examples

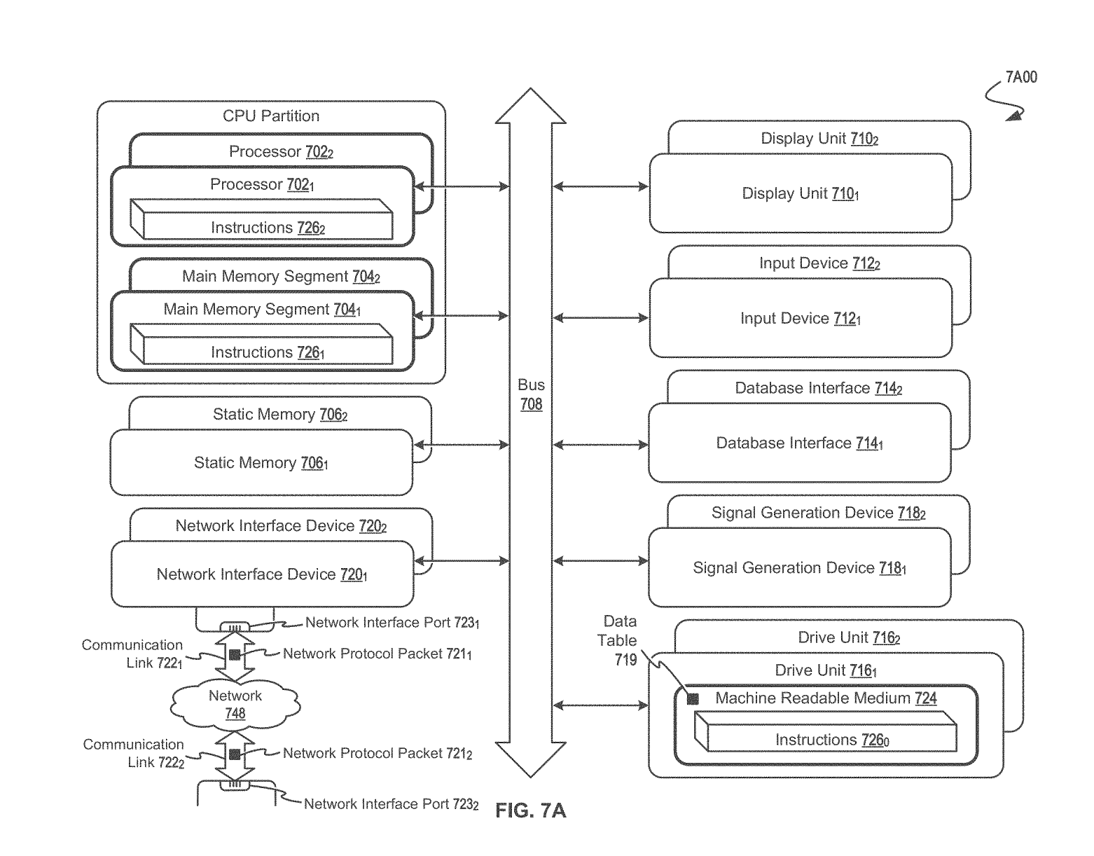

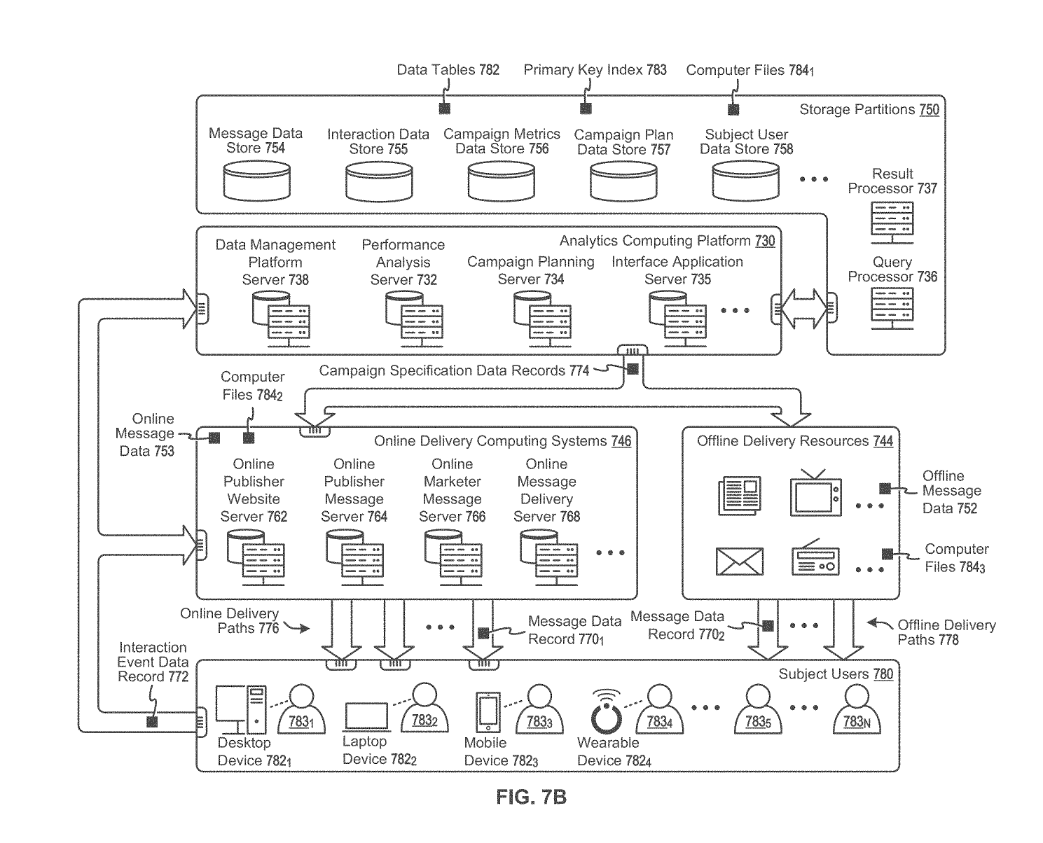

FIG. 7A depicts a diagrammatic representation of a machine in the exemplary form of a computer system 7A00 within which a set of instructions, for causing the machine to perform an one of the methodologies discussed above, may be executed. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 7A00 includes one or more processors (e.g., processor 702₁, processor 702₂, etc.), a main memory comprising one or more main memory segments (e.g., main memory segment 704₁, main memory segment 704₂, etc.), one or more static memories (e.g., static memory 706₁, static memory 706₂, etc.), which communicate with each other via a bus 708. The computer system 7A00 may further include one or more video display units (e.g., display unit 710₁ display unit 710₂, etc.), such as an LED display, or a liquid crystal display (LCD), or a cathode ray tube (CRT). The computer system 7A00 can also include one or more input devices (e.g., input device 712₁, input device 712₂, alphanumeric input device, keyboard, pointing device, mouse, etc.), one or more database interfaces (e.g., database interface 714₁, database interface 714₂, etc.), one or more disk drive units (e.g., drive unit 716₁, drive unit 716₂, etc.), one or more signal generation devices (e.g., signal generation device 718₁, signal generation device 718₂, etc.), and one or more network interface devices (e.g., network interface device 720₁, network interface device 720₂, etc.).

The disk drive units can include one or more instances of a machine-readable medium 724 on which is stored one or more instances of a data table 719 to store electronic information records. The machine-readable medium 724 can further store a set of instructions 726₀ (e.g., software) embodying any one, or all, of the methodologies described above. A set of instructions 726₁ can also be stored within the main memory (e.g., in main memory segment 704₁). Further, a set of instructions 726₂ can also be stored within the one or more processors (e.g., processor 702₁). Such instructions and/or electronic information may further be transmitted or received via the network interface devices at one or more network interface ports (e.g., network interface port 723₁, network interface port 723₂, etc.). Specifically, the network interface devices can communicate electronic information across a network using one or more optical links, Ethernet links, wireline links, wireless links, and/or other electronic communication links (e.g., communication link 722₁, communication link 722₂, etc.). One or more network protocol packets (e.g., network protocol packet 721₁, network protocol packet 721₂, etc.) can be used to hold the electronic information (e.g., electronic data records) for transmission across an electronic communications network (e.g., network 748). In some embodiments, the network 748 may include, without limitation, the web (i.e., the Internet), one or more local area networks (LANs), one or more wide area networks (WANs), one or more wireless networks, and/or one or more cellular networks.

The computer system 7A00 can be used to implement a client system and/or a server system, and/or any portion of network infrastructure.

It is to be understood that various embodiments may be used as or to support software programs executed upon some form of processing core (such as the CPU of a computer) or otherwise implemented or realized upon or within a machine or computer readable medium. A machine-readable medium includes any mechanism for storing or transmitting information in a form readable by a machine (e.g., a computer). For example, a machine-readable medium includes read-only memory (ROM); random access memory (RAM); magnetic disk storage media; optical storage media; flash memory devices; or any other type of non-transitory media suitable for storing or transmitting information.

A module as used herein can be implemented using an mix of any portions of the system memory, and any extent of hard-wired circuitry including hard-wired circuitry embodied as one or more processors (e.g., processor 702₁, processor 702₂, etc.).

FIG. 7B depicts a block diagram of a data processing system suitable for implementing instances of the herein-disclosed embodiments. The data processing system may include many more or fewer components than those shown.

The components of the data processing system may communicate electronic information (e.g., electronic data records) across various instances and/or types of an electronic communications network (e.g., network 1048) using one or more electronic communication links (e.g., communication link 722₁, communication link 722₂, etc.). Such communication links may further use supporting hardware, such as modems, bridges, routers, switches, wireless antennas and towers, and/or other supporting hardware. The various communication links transmit signals comprising data and commands (e.g., electronic data records) exchanged by the components of the data processing system, as well as any supporting hardware devices used to transmit the signals. In some embodiments, such signals are transmitted and received by the components at one or more network interface ports (e.g., network interface port 723₁, network interface port 723₂, etc.). In one or more embodiments, one or more network protocol packets (e.g., network protocol packet 721₁, network protocol packet 721₂, etc.) can be used to hold the electronic information comprising the signals.

As shown, the data processing system can be used by one or more advertisers to target a set of subject users 780 (e.g., user 783₁, user 783₂, user 783₃, user 783₄, user 783₅, to user 783_{N}) in various marketing campaigns. The data processing system can further be used to determine, by an analytics computing platform 730, various characteristics (e.g., performance metrics, etc.) of such marketing campaigns.

In some embodiments, the interaction event data record 772 comprises bottom up data suitable for computing, in performance analysis server 732, bottom up attribution. In other embodiments, the interaction event data record 772 and offline message data 752 comprise top down data suitable for computing, in performance analysis server 732, top down attribution. In yet other embodiments, the interaction event data record 772 and offline message data 752 comprises data suitable for computing, in performance analysis server 732, both bottom up and top down attribution.

The interaction event data record 772 comprises, in part, a plurality of touchpoint encounters that represent the subject users 780 exposure to marketing message(s). Each of these touchpoint encounters comprises a number of attributes, and each attribute comprises an attribute value. For example, the time of day during which the advertisement appeared, the frequency with which it was repeated, and the type of offer being advertised are all examples of attributes for a touchpoint encounter. Each attribute of a touchpoint may have a range of values. The attribute value range may be fixed or variable. For example, the range of attribute values for a day of the week attribute would be seven, whereas the range of values for a weather attribute may depend on the level of specificity desired. The attribute values may be objective (e.g., timestamp) or subjective (e.g., the relevance of the advertisement to the day's news cycle). For a “Publisher” attribute example (i.e., publisher of the marketing message), some examples of attribute values may be “Yahoo! Inc.”, “WSI.com”, “Seeking Alpha”, “NY Times Online”, “CBS Matchwatch”, “MSN Money”, “CBS Interactive”, “YuMe” and “IH Remnant.”

The interaction event data record 772 may pertain to various touchpoint encounters for an advertising or marketing campaign and the subject users 780 who encountered each touchpoint. The interaction event data record 772 may include entries that list each instance of a consumer's encounter with a touchpoint and whether or not that consumer converted. The interaction event data record 772 may be gathered from a variety of sources, such as Internet advertising impressions and responses (e.g., instances of an advertisement being serve to a user and the user's response, such as clicking on the advertisement). Offline message data 752 such as conversion data pertaining to television, radio, or print advertising, may be obtained from research and analytics agencies or other external entities that specialize in the collection of such data.

According to one embodiment, to compute bottom up attribution in performance analysis server 732, the raw touchpoint and conversion data (e.g., interaction event data record 772 and offline message data 752) is prepared for analysis. For example, the data may be grouped according to touchpoint, user, campaign, or any other scheme that facilitates ease of analysis. All of the subject users 780 that encountered the various touchpoints of a marketing campaign are identified. The subject users 780 are divided between those who converted (i.e., performed a desired action as a result of the marketing campaign) and those who did not convert, and the attributes and attribute values of each touchpoint encountered by the subject users 780 are identified. Similarly all of the subject users 780 that converted are identified. For each touchpoint encounter, this set of users is divided between those who encountered the touchpoint and those who did not. Using this data, the importance of each attribute of the various advertising touchpoints is determined, and the attributes of each touchpoint are ranked according to importance. Similarly, for each attribute and attribute value of each touchpoint, the likelihood that a potential value of that attribute might influence a conversion is determined.

According to some embodiments, attribute importance and attribute value importance may be modeled, using machine-learning techniques, to generate weights that are assigned to each attribute and attribute value, respectively. In some embodiments, the weights are determined by comparing data pertaining to converting users and non-converting users. In other embodiments, the attribute importance and attribute value importance may be determined by comparing conversions to the frequency of exposures to touchpoints with that attribute relative to others. In some embodiments, logistic regression techniques are used to determine the influence of each attribute and to determine the importance of each potential value of each attribute. Any machine-learning algorithm may be used without deviating from the spirit or scope of the invention.

An attribution algorithm is used and coefficients are assigned for the algorithm, respectively, using the attribute importance and attribute value importance weights. The attribution algorithm determines the relative effect of each touchpoint in influencing each conversion given the attribute weights and the attribute value weights. The attribution algorithm is executed using the coefficients or weights. According to one embodiment, for each conversion, the attribution algorithm outputs a score for every touchpoint that a user encountered prior to converting, wherein the score represents the touchpoint's relative influence on the user's decision to convert. The attribution algorithm, which calculates the contribution of the touchpoint to the conversion, may be expressed as a function of the attribute importance (e.g., attribute weights) and attribute value lift (e.g., attribute value weights):

Credit Fraction=Σₐ₌₁ⁿ f(attribute importanceₐ, attribute value liftₐ₎

wherein, “a” represents the attribute and “n” represents the number of attributes. Further details regarding a general approach to bottom up touchpoint attribution are described in U.S. application Ser. No. 13/492,493 (Attorney Docket No. VISQ.P0001) entitled, “A METHOD AND SYSTEM FOR DETERMINING TOUCHPOINT ATTRIBUTION”, filed Jun. 8, 2012, now U.S. Pat. No. 9,183,562, the contents of which are incorporated by reference in its entirety in this Application.

Performance analysis server 732 may also perform top down attribution. In general, a top down predictive model is used to determine the effectiveness of marketing stimulations in a plurality of marketing channels included in a marketing campaign. Data (interaction event data record 772 and Offline message data 752), comprising a plurality of marketing stimulations and respective measured responses, is used to determine a set of cross-channel weights to apply to the respective measured responses, where the cross-channel weights are indicative of the influence that a particular stimulation applied to a first channel has on the measure responses of other channels. The cross-channel weights are used in calculating the effectiveness of a particular marketing stimulation over an entire marketing campaign. The marketing campaign may comprise stimulations quantified as a number of direct mail pieces, a number or frequency of TV spots, a number of web impressions, a number of coupons printed, etc.

The top down predictive model takes into account cross-channel influence from more spending. For example, the effect of spending more on TV ads might influence viewers to “log in” (e.g., to access a website) and take a survey or download a coupon. The top down predictive model also takes into account counter-intuitive cross-channel effects from a single channel model. For example, additional spending on a particular channel often suffers from measured diminishing returns (e.g., the audience “tunes out” after hearing a message too many times). Placement of a message can reach a “saturation point” beyond which point further desired behavior is not apparent in the measurements in the same channel. However additional spending beyond the single-channel saturation point may correlate to improvements in other channels.

One approach to advertising portfolio optimization uses marketing attributions and predictions determined from historical data (interaction event data record 772 and Offline message data 732). Analysis of the historical data serves to infer relationships between marketing stimulations and responses. In some cases, the historical data comes from “online” outlets, and is comprised of individual user-level data, where a direct cause-effect relationship between stimulations and responses can be verified. However, “offline” marketing channels, such as television advertising, are of a nature such that indirect measurements are used when developing models used in media spend optimization. For example, some stimuli are described as an aggregate (e.g., “TV spots on Prime Time News, Monday, Wednesday and Friday”) that merely provides a description of an event or events as a time-series of marketing stimulations (e.g., weekly television advertising spends). Responses to such stimuli are also often measured and/or presented in aggregate (e.g., weekly unit sales reports provided by the telephone sales center). Yet, correlations, and in some cases causality and inferences, between stimulations and responses can be determined via statistical methods.

The top down predictive model considers cross-channel effects even when direct measurements are not available. The top down predictive model may be formed using any machine learning techniques. Specifically, top down predictive model may be formed using techniques where variations (e.g., mixes) of stimuli are used with the learning model to capture predictions of what would happen if a particular portfolio variation were prosecuted. The learning model produces a set of predictions, one set of predictions for each variation. In this manner, variations a stimuli produce predicted responses, which are used in weighting and filtering, which in turn result in a simulated model being output that includes cross-channel predictive capabilities.

In one example, a portfolio schematic includes three types of media, namely TV, radio and print media. Each media type may have one or more spends. For example, TV may include stations named CH1 and CH2. Radio includes a station named KVIQ 212. Print media may comprise distribution in the form of mail, a magazine and/or a printed coupon. For each media, there is one or more stimulations (e.g., S1, S2, . . . SN) and its respective response (e.g., R1, R2, R3 . . . RN). There is a one-to-one correspondence between a particular stimulus and its response. The stimuli and responses discussed herein are often formed as a time-series of individual stimulations and responses, respectively. For notational convenience, a time-series is given as a vector, such as vector S1.

Continuing the discussion of the example portfolio, the portfolio includes spends for TV, such as the evening news, weekly series, and morning show. The portfolio also includes radio spends in the form of a sponsored public service announcement, a sponsored shock jock spot, and a contest. The example portfolio may further include spends for radio station KVIQ, a direct mailer, and magazine print ads (e.g., coupon placement). The portfolio also includes spends for print media in the form of coupons.

The example portfolio may be depicted as stimulus vectors (e.g., S1, S2, S3, S4, S5, S6, S7, S8 and S). The example portfolio may also show a set of response measurements to be taken, such as response vectors (e.g., R1, R2, R3, R4, R5, R6, R7, R8, and RN).

A vector S̅1̅ may be comprised of a time-series. The time-series may be presented in a native time unit (e.g., weekly, daily) and may be apportioned over a different time unit. For example, stimulus S1 corresponds to a weekly spend for “Prime Time News” even though the stimulus to be considered actually occurs nightly (e.g., during “Prime Time News”). The weekly spend stimulus can be apportioned to a nightly stimulus occurrence. In some situations, the time unit in a time-series can be very granular (e.g., by the minute). Apportioning can be performed using any known techniques. Stimulus vectors and response vectors can be formed from any time-series in any time units and can be apportioned to another time-series using any other time units.

A particular stimulus in a first marketing channel (e.g., S̅1̅) might produce corresponding results (e.g., R̅1̅). Additionally, a stimulus in a first marketing channel (e.g., S̅1̅) might produce results (or lack of results) as given by measured results in a different marketing channel (e.g., R̅3̅). Such correlation of results, or lack of results, can be automatically detected, and a scalar value representing the extent of correlation can be determined mathematically from any pair of vectors. In the discussions just below, the correlation of a time-series response vector is considered with respect to a time-series stimulus vector. Correlations can be positive (e.g., the time-series data moves in the same directions), or negative (e.g., the time-series data moves in the opposite directions), or zero (no correlation).

An example vector S̅1̅ is comprised of a series of changing values. The response R̅1̅ may be depicted as a curve. Maximum value correlation occurs when the curve is relatively time-shifted, by Δt amount of time, to another. The amount of correlation and amount of time shift can be automatically determined. Example cross-channel correlations are presented in Table 1.

TABLE 1
Cross-correlation examples

| Stimulus Channel →Cross- | |
|---|---|
| channel | Description |
| S1 → R2 | No correlation. |
| S1 → R3 | Correlates if time shifted and attenuated |
| S1 → R4 | Correlates if time shifted and amplified |

In some cases, a correlation calculation can identify a negative correlation where an increase in a first channel causes a decrease in a second channel. Further, in some cases, a correlation calculation can identify an inverse correlation where a large increase in a first channel causes a small increase in a second channel. In still further cases, there can be no observed correlation, or in some cases correlation is increased when exogenous variables are considered.

In some cases a correlation calculation can hypothesize one or more causation effects. And in some cases correlation conditions are considered when calculating correlation such that a priori known conditions can be included (or excluded) from the correlation calculations.

The automatic detection can proceed autonomously. In some cases correlation parameters are provided to handle specific correlation cases. In one case, the correlation between two time-series can be determined to a scalar value using Eq. 1.

$$r = \frac{n \sum xy - ( \sum x ) ( \sum y )}{\sqrt{n ( \sum {x}^{2} ) - {( \sum x )}^{2}} \sqrt{n ( \sum {y}^{2} ) - {( \sum y )}^{2}}} \qquad ( 1 )$$

where:

x represents components of a first time-series,

y represents components of a second time-series, and

n is the number of {x, y} pairs.

In some cases, while modeling a time-series, not all the scalar values in the time-series are weighted equally. For example, more recent time-series data values found in the historical data are given a higher weight as compared to older ones. Various shapes of eights to overlay a time-series are possible, and one exemplary shape is the shape of an exponentially decaying model.

Use of exogenous variables might involve considering seasonality factors or other factors that are hypothesized to impact, or known to impact, the measured responses. For example, suppose the notion of seasonality is defined using quarterly time graduations. And the measured data shows only one quarter (e.g., the 4^{th} quarter) from among a sequence of four quarters in which a significant deviation of a certain response is present in the measured data. In such a case, the exogenous variables 57 can define a variable that lumps the 1^{st} through 3^{rd} quarters into one variable and the 4^{th} quarter in a separate variable.

Further details of a top down predictive model are described in U.S. application Ser. No. 14/145,625 (Attorney Docket No. VISQ.P0004) entitled, “MEDIA SPEND OPTIMIZATION USING CROSS-CHANNEL PREDICTIVE MODEL”, filed Dec. 31, 2013, the contents of which are incorporated by reference in its entirety in this Application.

Other operations, transactions, and/or activities associated with the data processing system are possible. Specifically, the subject users 780 can receive a plurality of online message data 753 transmitted through any of a plurality of online delivery paths 776 (e.g., online display, search, mobile ads, etc.) to various computing devices (e.g., desktop device 782₁, laptop device 782₂, mobile device 782₃, and wearable device 782₄). The subject users 780 can further receive a plurality of offline message data 752 presented through any of a plurality of offline delivery paths 778 (e.g., TV, radio, print, direct mail, etc.). The online message data 753 and/or the offline message data 752 can be selected for delivery to the subject users 780 based in part on certain instances of campaign specification data records 774 (e.g., established by the advertisers and/or the analytics computing platform 730). For example, the campaign specification data records 774 might comprise settings, rules, taxonomies, and other information transmitted electronically to one or more instances of online delivery computing systems 746 and/or one or more instances of offline delivery resources 744. The online delivery computing systems 746 and/or the offline delivery resources 744 can receive and store such electronic information in the form of instances of computer files 784₂ and computer files 784₂, respectively. In one or more embodiments, the online delivery computing systems 746 can comprise computing resources such as an online publisher website server 762, an online publisher message server 764, an online marketer message server 766, an online message delivery server 768, and other computing resources. For example, the message data record 770₁ presented to the subject users 780 through the online delivery paths 776 can be transmitted through the communications links of the data processing system as instances of electronic data records using various protocols (e.g., HTTP, HTTPS, etc.) and structures (e.g., JSON), and rendered on the computing devices in various forms (e.g., digital picture, hyperlink, advertising tag, text message, email message, etc.). The message data record 770₂ presented to the subject users 780 through the offline delivery paths 778 can be transmitted as sensory signals in various forms (e.g., printed pictures and text, video, audio, etc.).

The analytics computing platform 730 can receive instances of an interaction event data record 772 comprising certain characteristics and attributes of the response of the subject users 780 to the message data record 770₁, the message data record 770₂, and/or other received messages. For example, the interaction event data record 772 can describe certain online actions taken by the users on the computing devices, such as visiting a certain URL, clicking a certain link, loading a web page that fires a certain advertising tag, completing an online purchase, and other actions. The interaction event data record 772 may also include information pertaining to certain offline actions taken by the users, such as purchasing a product in a retail store, using a printed coupon, dialing a toll-free number, and other actions. The interaction event data record 772 can be transmitted to the analytics computing platform 730 across the communications links as instances of electronic data records using various protocols and structures. The interaction event data record 772 can further comprise data (e.g., user identifier, computing device identifiers, timestamps, IP addresses, etc.) related to the users and/or the users' actions.

The interaction event data record 772 and other data generated and used by the analytics computing platform 730 can be stored in one or more storage partitions 750 (e.g., message data store 754, interaction data store 755, campaign metrics data store 756, campaign plan data store 757, subject user data store 758, etc.). The storage partitions 750 can comprise one or more databases and/or other types of non-volatile storage facilities to store data in various formats and structures (e.g., data tables 782, computer files 784₁ etc.). The data stored in the storage partitions 750 can be made accessible to the analytics computing platform 730 by a query processor 736 and a result processor 737, which can use various means for accessing and presenting the data, such as a primary key index 783 and/or other means. In one or more embodiments, the analytics computing platform 730 can comprise a performance analysis server 732 and a campaign planning server 734. Operations performed by the performance analysis server 732 and the campaign planning server 734 can vary widely by embodiment. As an example, the performance analysis server 732 can be used to analyze the messages presented to the users (e.g., message data record 770₁ and message data record 770₂) and the associated instances of the interaction event data record 772 to determine various performance metrics associated with a marketing campaign, which metrics can be stored in the campaign metrics data store 756 and/or used to generate various instances of the campaign specification data records 774. Further, for example, the campaign planning server 734 can be used to generate marketing campaign plans and associated marketing spend apportionments, which information can be stored in the campaign plan data store 757 and/or used to generate various instances of the campaign specification data records 774. Certain portions of the interaction event data record 772 might further be used by a data management platform server 738 in the analytics computing platform 730 to determine various user attributes (e.g., behaviors, intent, demographics, device usage, etc.), which attributes can be stored in the subject user data store 758 and/or used to generate various instances of the campaign specification data records 774. One or more instances of an interface application server 735 can execute various software applications that can manage and/or interact with the operations, transactions, data, and/or activities associated with the analytics computing platform 730. For example, a marketing manager might interface with the interface application server 735 to view the performance of a marketing campaign and/or to allocate media spend for another marketing campaign.

In the foregoing specification, the disclosure has been described with reference to specific embodiments thereof. It will, however, be evident that various modifications and changes may be made thereto without departing from the broader spirit and scope of the disclosure. For example, the above-described process flows are described with reference to a particular ordering of process actions. However, the ordering of many of the described process actions may be changed without affecting the scope or operation of the disclosure. The specification and drawings are, accordingly, to be regarded in an illustrative sense rather than in a restrictive sense.

What is claimed is:

1. A computer implemented method comprising:
executing, on a computer, an offer management application to operate on at least one management interface device;
storing, in a computer, a plurality of touchpoint encounters that represent marketing messages exposed to a plurality of users across a plurality of media channels;
storing, in a computer, a plurality of historical response vectors that characterize one or more performance metrics of the users exposed to the touchpoint encounters;
processing, using machine-learning techniques in a computer, the touchpoint encounters and the historical response vectors to generate at least one stimulus attribution predictive model comprising stimulus attribution predictive model input variables, wherein the stimulus attribution predictive model predicts market performance of a future marketing message based on the stimulus attribution predictive model input variables;
executing, on one or more computers, to predict marketing performance of at least one offer as a marketing message, operations comprising:
receiving a plurality of offer specification parameters that characterize the offer to be presented over at least one of the media channels, wherein the offer specification parameters comprise a unique combination of parameters not presented in the touchpoint encounters and the historical response vectors;
mapping at least one of the offer specification parameters to at least one of the stimulus attribution predictive model input variables; and
generating a predicted response to the offer by executing the stimulus attribution predictive model using the offer specification parameters to corresponding inputs of the stimulus attribution predictive model.

2. The computer implemented method of claim 1, further comprising delivering the predicted response to the management interface device to be displayed to a user.

3. The computer implemented method of claim 1, further comprising receiving, over a network, from the management interface device, a selected media spend plan.

4. The computer implemented method of claim 1, further comprising selecting, responsive to receiving the plurality of offer specification parameters, at least one of, additional touchpoint encounters, or additional historical response vectors, or any combination thereof.

5. The computer implemented method of claim 4, wherein the selecting is based at least in part on a historical period.

6. The computer implemented method of claim 1, further comprising determining one or more simulated offer mix performance measurements based at least in part on the predicted response.

7. The computer implemented method of claim 1, further comprising determining one or more predicted media spend allocation response parameters based at least in part on the predicted response.

8. The computer implemented method of claim 7, wherein the predicted media spend allocation response parameters are further based at least in part on relative media spend allocation for the one or more offers.

9. The computer implemented method of claim 1, wherein mapping of at least one of the offer specification parameters to at least one of the stimulus attribution predictive model input variables is based at least in part on a set of offer specification rules.

10. The computer implemented method of claim 1, wherein at least one of the offer specification parameters is associated with at least one of, a duration, or an activation fee, or a monthly rate, or a discount, or a product, or a package, or a geography, or any combination thereof.

11. A computer readable medium, embodied in a non-transitory computer readable medium, the non-transitory computer readable medium having stored thereon a sequence of instructions which, when stored in memory and executed by a processor causes the processor to perform a set of acts, the acts comprising:
executing, on a computer, an offer management application to operate on at least one management interface device;
storing, in a computer, a plurality of touchpoint encounters that represent marketing messages exposed to a plurality of users across a plurality of media channels;
storing, in a computer, a plurality of historical response vectors that characterize one or more performance metrics of the users exposed to the touchpoint encounters;
processing, using machine-learning techniques in a computer, the touchpoint encounters and the historical response vectors to generate at least one stimulus attribution predictive model comprising stimulus attribution predictive model input variables, wherein the stimulus attribution predictive model predicts market performance of a future marketing message based on the stimulus attribution predictive model input variables;
executing, on one or more computers, to predict marketing performance of at least one offer as a marketing message, operations comprising:
receiving a plurality of offer specification parameters that characterize the offer to be presented over at least one of the media channels, wherein the offer specification parameters comprise a unique combination of parameters not presented in the touchpoint encounters and the historical response vectors;
mapping at least one of the offer specification parameters to at least one of the stimulus attribution predictive model input variables; and
generating a predicted response to the offer by executing the stimulus attribution predictive model using the offer specification parameters to corresponding inputs of the stimulus attribution predictive model.

12. The computer readable medium of claim 11, further comprising instructions which, when stored in memory and executed by the processor causes the processor to perform acts of delivering the predicted response to the management interface device to be displayed to a user.

13. The computer readable medium of claim 11, further comprising instructions which, when stored in memos and executed by the processor causes the processor to perform acts of receiving, over a network, from the management interface device, a selected media spend plan.

14. The computer readable medium of claim 11, further comprising instructions which, when stored in memory and executed by the processor causes the processor to perform acts of selecting, responsive to receiving the plurality of offer specification parameters, at least one of, additional touchpoint encounters, OF additional historical response vectors, or any combination thereof.

15. The computer readable medium of claim 14, wherein the selecting is based at least in part on a historical period.

16. The computer readable medium of claim 11, further comprising instructions which, when stored in memory and executed by the processor causes the processor to perform acts of determining one or more simulated offer mix performance measurements based at least in part on the predicted response.

17. The computer readable medium of claim 11, further comprising instructions which, when stored in memory and executed by the processor causes the processor to perform acts of determining one or more predicted media spend allocation response parameters based at least in part on the predicted response.

18. A system comprising:
a storage medium having stored thereon a sequence of instructions; and
a processor or processors that execute the instructions to cause the processor or processors to perform a set of acts, the acts comprising,
executing an offer management application to operate on at least one management interface device;
storing, a plurality of touchpoint encounters that represent marketing messages exposed to a plurality of users across a plurality of media channels;
storing, a plurality of historical response vectors that characterize one or more performance metrics of the users exposed to the touchpoint encounters;
processing, using machine-learning techniques, the touchpoint encounters and the historical response vectors to generate at least one stimulus attribution predictive model comprising stimulus attribution predictive model input variables, wherein the stimulus attribution predictive model predicts market performance of a future marketing message based on the stimulus attribution predictive model input variables;
executing, instructions for performing acts to predict marketing performance of at least one offer as a marketing message, the acts comprising at least:
receiving a plurality of offer specification parameters that characterize the offer to be presented over at least one of the media channels, wherein the offer specification parameters comprise a unique combination of parameters not presented in the touchpoint encounters and the historical response vectors;
mapping at least one of the offer specification parameters to at least one of the stimulus attribution predictive model input variables; and
generating a predicted response to the offer by executing the stimulus attribution predictive model using the offer specification parameters to corresponding inputs of the stimulus attribution predictive model.

19. The system of claim 18, wherein the selecting is based at least in part on a historical period.

20. The system of claim 18, wherein predicted media spend allocation response parameters are based at least in part on relative media spend allocation for the one or more offers.
